(19) United States
(12) Patent Application Publication
(10) Pub. No.: US 2023/0041630 A1
(43) Pub. Date: Feb. 9, 2023

(54) TECHNIQUES FOR PHASE DETECTION AUTOFOCUS

(71) Applicant: QUALCOMM Incorporated, San Diego, CA (US)

(72) Inventors: Micha Haridas Galor Gluskin, San Diego, CA (US); Krishnam Indukuri, San Diego, CA (US)

(21) Appl. No.: 17/396,360

(22) Filed: Aug. 6, 2021

(51) Int. Cl. H04N 5/232

(52) U.S. Cl. CPC H04N 5/232122; H04N 9/04551

(57) ABSTRACT

Methods, systems, and devices for techniques for phase detection autofocus (PDAF) are described. A device may receive a set of PDAF pixels and may rearrange the set of PDAF pixels into a first subset of pixels in a first line buffer and a second subset of pixels in a second line buffer. As part of a first output operation, the device may perform a uniformity correction on the first subset of pixels, output the first subset of pixels to a left, center, right (LCR) processing path, and write-back the corrected first subset of pixels to the first line buffer. As part of a second output operation, the device may perform a uniformity correction on the second subset of pixels, output the second subset of pixels to an LCR processing path and an interleaver, and pull the corrected first subset of pixels from the first line buffer to the interleaver.

### FIELD OF TECHNOLOGY

The following relates to autofocus control, including techniques for phase detection autofocus (PDAF).

### BACKGROUND

Systems are widely deployed to provide various types of media communication content such as voice, video, packet data, messaging, broadcast, and so on. These systems may be capable of processing, storage, generation, manipulation and rendition of media information. Examples of systems include entertainment systems, information systems, virtual reality systems, model and simulation systems, and so on. These systems may employ a combination of hardware and software technologies to support processing, storage, generation, manipulation and rendition of media information, for example, such as capture devices, storage devices, communication networks, computer systems, and display devices. Some systems may deploy camera sensors including a variety of diverse PDAF patterns. In some cases, to support the various PDAF patterns, these systems may have to implement extra resources (e.g., processing blocks), which may limit a performance of the systems.

### SUMMARY

Various aspects of the present disclosure relate to enabling a device (e.g., a camera-enabled device) to using same line buffers for consumption via multiple processing paths or iterations. The device may implement a rearranging and binning procedure with multiple flush or output patterns and gain map toggles, which may enable the device to efficiently perform a uniformity correction for each line buffer. That is, the device may perform a single uniformity correction for each line buffer, while using the multiple line buffers for multiple different processing paths. For example, the device may receive a set of pixels associated with a frame as raw input data and may store a first subset of pixels in a first line buffer and may store a second subset of pixels in a second line buffer. The device may store the two subsets of pixels in their respective line buffers as a result of rearranging the set of pixels into left, right (LR) channels in accordance with a non-sequential read-add-writeback procedure.

The device may perform a first output operation for the first subset of pixels according to which the device may perform a uniformity correction for the first subset of pixels, output the corrected first subset of pixels to a first left, center, right (LCR) processing path, and writeback the corrected first subset of pixels to the first line buffer. The device may perform a second output operation for the second subset of pixels according to which the device may perform a uniformity correction for the second subset of pixels and output the corrected second subset of pixels to a second LCR processing path. The device may, as part of the second output operation, output both the corrected first subset of pixels (which the device may pull from the first line buffer as a result of the writeback operation) and the corrected second subset of pixels to an interleaving block. The device may process the corrected first subset of pixels using the first LCR path, process the corrected second subset of pixels using the second LCR path, and interleave the corrected first subset of pixels and the corrected subset of pixels for LR processing.

A method for performing PDAF at a device is described. The method may include selecting a first subset of pixels of a set of pixels associated with a frame and a second subset of pixels of the set of pixels associated with the frame, each of the first subset of pixels and the second subset of pixels including at least two pixels, performing a first output operation by outputting, from a first line buffer, the first subset of pixels to a first set of pixel channels, performing a second output operation by outputting, from a second line buffer, the second subset of pixels to a second set of pixel channels and an interleaver, and outputting a phase detection autofocus parameter associated with the frame based on the first output operation and the second output operation.

An apparatus for performing PDAF at a device is described. The apparatus may include a processor, memory coupled with the processor, and instructions stored in the memory. The instructions may be executable by the processor to cause the apparatus to select a first subset of pixels of a set of pixels associated with a frame and a second subset of pixels of the set of pixels associated with the frame, each of the first subset of pixels and the second subset of pixels including at least two pixels, perform a first output operation by outputting, from a first line buffer, the first subset of pixels to a first set of pixel channels, perform a second output operation by outputting, from a second line buffer, the second subset of pixels to a second set of pixel channels and an interleaver, and output a phase detection autofocus parameter associated with the frame based on the first output operation and the second output operation.

Another apparatus for performing PDAF at a device is described. The apparatus may include means for selecting a first subset of pixels of a set of pixels associated with a frame and a second subset of pixels of the set of pixels associated with the frame, each of the first subset of pixels and the second subset of pixels including at least two pixels, means for performing a first output operation by outputting, from a first line buffer, the first subset of pixels to a first set of pixel channels, means for performing a second output operation by outputting, from a second line buffer, the second subset of pixels to a second set of pixel channels and an interleaver, and means for outputting a phase detection autofocus parameter associated with the frame based on the first output operation and the second output operation.

A non-transitory computer-readable medium storing code for performing PDAF at a device is described. The code may include instructions executable by a processor to select a first subset of pixels of a set of pixels associated with a frame and a second subset of pixels of the set of pixels associated with the frame, each of the first subset of pixels and the second subset of pixels including at least two pixels, perform a first output operation by outputting, from a first line buffer, the first subset of pixels to a first set of pixel channels, perform a second output operation by outputting, from a second line buffer, the second subset of pixels to a second set of pixel channels and an interleaver, and output a phase detection autofocus parameter associated with the frame based on the first output operation and the second output operation.

Some examples of the method, apparatuses, and non-transitory computer-readable medium described herein may further include operations, features, means, or instructions for performing a first uniformity correction on the first subset of pixels to obtain a corrected first subset of pixels, where outputting the first subset of pixels to the first set of pixel channels includes outputting the corrected first subset of pixels and writing, to the first line buffer, the corrected first subset of pixels.

Some examples of the method, apparatuses, and non-transitory computer-readable medium described herein may further include operations, features, means, or instructions for performing a second uniformity correction on the second subset of pixels to obtain a corrected second subset of pixels, where outputting the second subset of pixels to the second set of pixel channels and the interleaver includes outputting the corrected second subset of pixels.

Some examples of the method, apparatuses, and non-transitory computer-readable medium described herein may further include operations, features, means, or instructions for rearranging the set of pixels into the first subset of pixels and the second subset of pixels, where pixels of the first subset of pixels may be rearranged to locations in the first line buffer and pixels of the second subset of pixels may be rearranged to locations in the second line buffer and storing the first subset of pixels in the first line buffer and the second subset of pixels in the second line buffer based on the rearranging.

In some examples of the method, apparatuses, and non-transitory computer-readable medium described herein, rearranging the set of pixels into the first subset of pixels and the second subset of pixels may include operations, features, means, or instructions for rearranging a first pixel of the set of pixels to a first location in the first line buffer and rearranging a second pixel of the set of pixels to a second location in the second line buffer, and some examples of the method, apparatuses, and non-transitory computer-readable medium described herein may further include operations, features, means, or instructions for performing a first vertical binning operation for the first pixel at the first location in the first line buffer and performing a second vertical binning operation for the second pixel at the second location in the second line buffer.

In some examples of the method, apparatuses, and non-transitory computer-readable medium described herein, performing the first vertical binning operation may include operations, features, means, or instructions for reading a value of the first location in the first line buffer, adding a first value corresponding to the first pixel to the value of the first location in the first line buffer, and writing, to the first location in the first line buffer, a first sum value based on adding the first value corresponding to the first pixel to the value of the first location in the first line buffer.

In some examples of the method, apparatuses, and non-transitory computer-readable medium described herein, performing the second vertical binning operation may include operations, features, means, or instructions for reading a value of the second location in the second line buffer, adding a second value corresponding to the second pixel to the value of the second location in the second line buffer, and writing, to the second location in the second line buffer, a second sum value based on adding the second value corresponding to the second pixel to the value of the second location in the second line buffer.

In some examples of the method, apparatuses, and non-transitory computer-readable medium described herein, the first set of pixel channels comprise a first LCR processing path and the second set of pixel channels comprise a second LCR processing path and the method, apparatuses, and non-transitory computer-readable medium may include further operations, features, means, or instructions for processing the first subset of pixels using the first LCR processing path and processing the second subset of pixels using the second LCR processing path.

In some examples of the method, apparatuses, and non-transitory computer-readable medium described herein, processing the first subset of pixels using the first LCR processing path may include operations, features, means, or instructions for comparing a left pixel channel associated with the first subset of pixels to a center pixel channel associated with the set of pixels and comparing the center pixel channel associated with the set of pixels to a right pixel channel associated with the first subset of pixels.

In some examples of the method, apparatuses, and non-transitory computer-readable medium described herein, processing the second subset of pixels using the second LCR processing path may include operations, features, means, or instructions for comparing a left pixel channel associated with the second subset of pixels to a center pixel channel associated with the set of pixels and comparing the center pixel channel associated with the set of pixels to a right pixel channel associated with the second subset of pixels.

Some examples of the method, apparatuses, and non-transitory computer-readable medium described herein may further include operations, features, means, or instructions for interleaving, at the interleaver, the first subset of pixels and the second subset of pixels to obtain an interleaved set of pixels and outputting the interleaved set of pixels to a first LR processing component and a second LR processing component.

### BRIEF DESCRIPTION OF THE DRAWINGS

FIG. 1 illustrates an example of a media system that supports techniques for PDAF in accordance with aspects of the present disclosure.

FIG. 2 illustrates an example of a device that supports techniques for PDAF in accordance with aspects of the present disclosure.

FIG. 3 illustrates examples of processing timelines that support techniques for PDAF in accordance with aspects of the present disclosure.

FIG. 4 illustrates an example of a processing diagram that supports techniques for PDAF in accordance with aspects of the present disclosure.

FIG. 5 illustrates an example of a rearranging and binning diagram that supports techniques for PDAF in accordance with aspects of the present disclosure.

FIG. 6 illustrates an example of a processing diagram that supports techniques for PDAF in accordance with aspects of the present disclosure.

FIG. 7 illustrates an example of a hybrid output that supports techniques for PDAF in accordance with aspects of the present disclosure.

FIG. 8 illustrates an example of a dual phase detection (2PD) PDAF pattern that supports techniques for PDAF in accordance with aspects of the present disclosure.

FIG. 9 illustrates an example of a quad phase detection (QPD) PDAF pattern that supports techniques for PDAF in accordance with aspects of the present disclosure.

FIG. 10 illustrates an example of a quad color filter array (QCFA) PDAF pattern that supports techniques for PDAF in accordance with aspects of the present disclosure.

FIG. 11 illustrates an example of a sparse horizontal and vertical PDAF pattern that supports techniques for PDAF in accordance with aspects of the present disclosure.

FIGS. 12 and 13 show block diagrams of devices that support techniques for PDAF in accordance with aspects of the present disclosure.

FIG. 14 shows a block diagram of a PDAF manager that supports techniques for PDAF in accordance with aspects of the present disclosure.

FIG. 15 shows a diagram of a system including a device that supports techniques for PDAF in accordance with aspects of the present disclosure.

FIGS. 16 through 18 show flowcharts illustrating methods that support techniques for PDAF in accordance with aspects of the present disclosure.

### DETAILED DESCRIPTION

A device may support various PDAF patterns for image capturing and processing operations. In some cases, supporting these various PDAF patterns may be computationally expensive for the device. For example, image sensors of the device may use or output multiple different sparse PDAF patterns (e.g., 50 different sparse PDFAF patterns or more), different full PDAF patterns, or different horizontal or vertical PDAF patterns. In some other cases, the device may control multiple cameras and sensors, and each camera may support a different PDAF pattern. Some PDAF patterns may be associated with low horizontal density, which may result in or be associated with the use of multiple processing of same data in different ways to compensate for the low horizontal density. Some other PDAF patterns may be associated with high horizontal density, which may result in or be associated with the use of wide line buffers (e.g., to efficiently capture the high horizontal density and corresponding benefits).

Various aspects of the present disclosure relate to enabling the device to handle each permutation of PDAF pattern. The device may receive or select a set of pixels as a PDAF input and the set of pixels may include data of both left and right pixels. The device may rearrange the set of pixels to interleave different pixels with each other. In examples in which there are four pixels in a block, for instance, the device may interleave a first repeating pixel (e.g., a left pixel) and a second repeating pixel (e.g., a right pixel) of a PDAF pattern to obtain a first subset of pixels for a first line buffer and may interleave a third repeating pixel (e.g., a left pixel) and a fourth repeating pixel (e.g., a right pixel) of the PDAF pattern to obtain a second subset of pixels for a second line buffer. The device may use the first subset of pixels and the second subset of pixels for multiple processing paths, such as an LR processing path with reduced noise, an LR processing path without reduced noise, or an LCR processing path, or any combination thereof.

In some examples, the device may output the pixels to the different processing paths with different levels of interleaving. For example, the device may output the first subset of pixels and the second subset of pixels (e.g., which may both be associated with some partial interleaving) to one or more LCR processing paths and may output the first subset of pixels and the second subset of pixels to an interleaving block to obtain a fully interleaved set of pixels for one or more LR processing paths. Additionally or alternatively, the device may provide non-interleaved pixels to one or more LCR processing paths (and provide fully or partially interleaved pixels to one or more LR processing paths). As a result of providing pixels associated with different levels of interleaving to different processing paths from the first line buffer and the second line buffer (e.g., a single set of line buffers), the device may re-use the same line buffers for multiple processing paths. Further, the device may employ multiple output operations or modes (which may be referred to herein as flush operations or modes), such as hybrid outputs, to transmit the pixels from the line buffers to the various processing paths.

Particular aspects of the subject matter described in the present disclosure can be implemented to realize one or more of the following potential advantages. For example, as a result of re-using same line buffers for multiple processing paths and providing pixels associated with different levels of interleaving to different processing paths, the device (or a processing block of the device) may use less device footprint while maintaining or increasing device performance. In other words, a device implementing the described techniques may achieve an area or size reduction (e.g., may feature a smaller footprint) and may experience greater processing speed, greater image quality, greater algorithmic accuracy, or lower power costs.

Aspects of the present disclosure are initially described in the context of a media system. Aspects of the disclosure are additionally illustrated by and described with reference to system diagrams, PDAF diagrams, processing timelines, processing diagrams, a hybrid output, and various PDFAF patterns. Aspects of the disclosure are further illustrated by and described with reference to apparatus diagrams, system diagrams, and flowcharts that relate to techniques for PDAF.

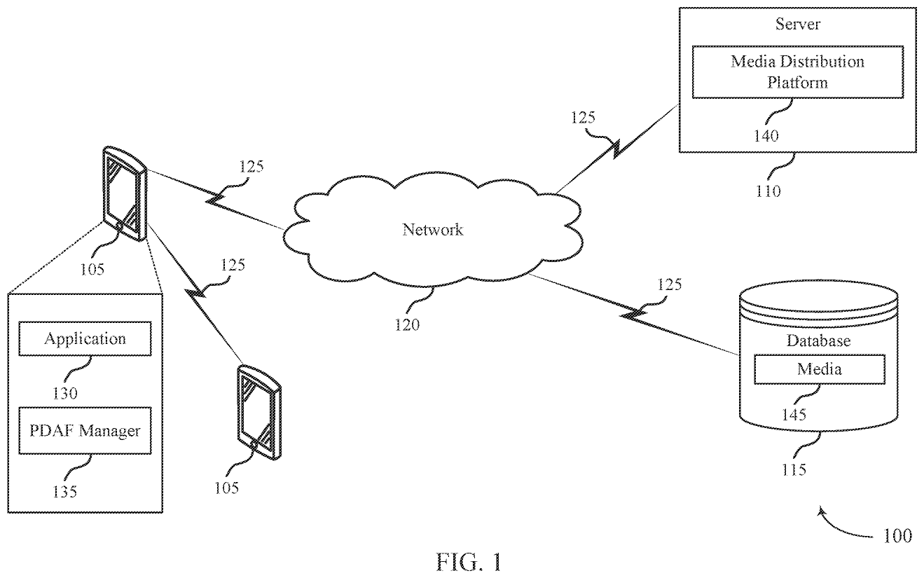

FIG. 1 illustrates a media system for a device that supports techniques for PDAF in accordance with aspects of the present disclosure. The media system 100 may include devices 105, a server 110, and a database 115. Although, the media system 100 illustrates two devices 105, a single server 110, a single database 115, and a single network 120, the present disclosure applies to any media system architecture having one or more devices 105, servers 110, databases 115, and networks 120. The devices 105, the server 110, and the database 115 may communicate with each other and exchange information that supports techniques for PDAF, such as media packets, media data, or media control information, via network 120 using communications links 125. In some cases, a portion or all of the techniques described herein supporting techniques for PDAF may be performed by the devices 105 or the server 110, or both.

A device 105 may be a cellular phone, a smartphone, a personal digital assistant (PDA), a wireless communication device, a handheld device, a tablet computer, a laptop computer, a cordless phone, or a display device (e.g., monitors), among other examples, that supports various types of communication and functional features related to media (e.g., transmitting, receiving, broadcasting, streaming, sinking, capturing, storing, and recording media data). A device 105 may, additionally or alternatively, be referred to by those skilled in the art as a user equipment (UE), a user device, a smartphone, a Bluetooth device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, or some other suitable terminology. In some cases, the devices 105 may also be able to communicate directly with another device (e.g., using a peer-to-peer (P2P) or device-to-device (D2D) protocol). For example, a device 105 may be able to receive from or transmit to another device 105 variety of information, such as instructions or commands (e.g., media-related information).

The devices 105 may include an application 130 and a PDAF manager 135. While, the media system 100 illustrates the devices 105 including both the application 130 and the PDAF manager 135, the application 130 and the PDAF manager 135 may be an optional feature for the devices 105. In some cases, the application 130 may be a media-based application that can receive (e.g., download, stream, broadcast) from the server 110, database 115 or another device 105, or transmit (e.g., upload) media data to the server 110, the database 115, or to another device 105 via using communications links 125.

The PDAF manager 135 may be part of a general-purpose processor, a digital signal processor (DSP), an image signal processor (ISP), a central processing unit (CPU), a graphics processing unit (GPU), a microcontroller, an application-specific integrated circuit (ASIC), a field-programmable gate array (FPGA), a discrete gate or transistor logic component, a discrete hardware component, or any combination thereof, or other programmable logic device, discrete gate or transistor logic, discrete hardware components, or any combination thereof designed to perform the functions described in the present disclosure, among other examples. For example, the PDAF manager 135 may process media (e.g., image data, video data, audio data) from or write media data to a local memory of the device 105 or to the database 115.

The PDAF manager 135 may also be configured to provide media enhancements, media restoration, media analysis, media compression, media streaming, and media synthesis, among other functionality. For example, the PDAF manager 135 may perform white balancing, cropping, scaling (e.g., media compression), adjusting a resolution, media stitching, color processing, media filtering, spatial media filtering, artifact removal, frame rate adjustments, media encoding, media decoding, and media filtering. By further example, the PDAF manager 135 may process media data to support techniques for PDAF, according to the techniques described herein.

The server 110 may be a data server, a cloud server, a server associated with a media subscription provider, proxy server, web server, application server, communications server, home server, mobile server, or any combination thereof. The server 110 may in some cases include a media distribution platform 140. The media distribution platform 140 may allow the devices 105 to discover, browse, share, and download media via network 120 using communications links 125, and therefore provide a digital distribution of the media from the media distribution platform 140. As such, a digital distribution may be a form of delivering media content such as audio, video, images, without the use of physical media but over online delivery mediums, such as the Internet. For example, the devices 105 may upload or download media-related applications for streaming, downloading, uploading, processing, enhancing, etc. media (e.g., images, audio, video). The server 110 may also transmit to the devices 105 a variety of information, such as instructions or commands (e.g., media-related information) to download media-related applications on the device 105.

The database 115 may store a variety of information, such as instructions or commands (e.g., media-related information). For example, the database 115 may store media 145. The device may support techniques for PDAF associated with the media 145. The device 105 may retrieve the stored data from the database 115 via the network 120 using communications links 125. In some examples, the database 115 may be a relational database (e.g., a relational database management system (RDBMS) or a Structured Query Language (SQL) database), a non-relational database, a network database, an object-oriented database, or other type of database, that stores the variety of information, such as instructions or commands (e.g., media-related information).

The network 120 may provide encryption, access authorization, tracking, Internet Protocol (IP) connectivity, and other access, computation, modification, or functions. Examples of network 120 may include any combination of cloud networks, local area networks (LAN), wide area networks (WAN), virtual private networks (VPN), wireless networks (using 802.11, for example), cellular networks (using third generation (3G), fourth generation (4G), long-term evolved (LTE), or new radio (NR) systems (e.g., fifth generation (5G)), etc. Network 120 may include the Internet.

The communications links 125 shown in the media system 100 may include uplink transmissions from the device 105 to the server 110 and the database 115, or downlink transmissions, from the server 110 and the database 115 to the device 105. The communications links 125 may transmit bidirectional communications or unidirectional communications. In some examples, the communications links 125 may be a wired connection or a wireless connection, or both. For example, the communications links 125 may include one or more connections, including but not limited to, Wi-Fi, Bluetooth, Bluetooth low-energy (BLE), cellular, Z-WAVE, 802.11, peer-to-peer, LAN, wireless local area network (WLAN), Ethernet, FireWire, fiber optic, or other connection types related to wireless communication systems.

In some camera deployments, sensors of the device 105 may support a variety of diverse PDAF patterns and, in some examples, it may be challenging for one hardware design to target a diversity of PDAF patterns. As such, some hardware designs may exclusively support small resolution sensors while some other hardware designs may exclusively support sensors with blanking between lines. In other words, such hardware designs may be unable to target all PDAF patterns and may instead target different subsets of PDAF patterns (e.g., based on input data size or rates). Some PDAF patterns may include many different sparse patterns (e.g., 50 or more) according to which not all pixels are for PDAF, full PDAF patterns according to which all pixels are for PDAF (e.g., dual phase detection (2PD), quad phase detection (QPD), horizontal and vertical 2PD (HV2PD), or 8PD), PDAF T2/T3, and horizontal and vertical patterns). Further, the device 105 (e.g., a phone) may have multiple cameras (e.g., such as 4 back cameras), and each of the multiple cameras may have a different flavor of PDAF.

Such a hardware design that supports diverse PDAF patterns may, however, provide benefits in terms of processing efficiency and area reduction. For example, such a hardware design that targets a diversity of PDAF patterns may be associated with or provide an area reduction for a PDAF processing block (e.g., a 50% or more area reduction for matching capabilities). Various implementations of the present disclosure provide processing techniques and hardware for such a hardware design that is capable of targeting a diversity of PDAF patterns.

In some implementations, the device 105 may receive a PDAF input of a set of pixels, may rearrange the set of pixels into left and right channels, and may store the rearranged pixels in line buffers. For example, the device 105 may obtain a first subset of pixels and store the first subset of pixels in a first line buffer and may obtain a second subset of pixels and store the second subset of pixels in a second line buffer. As part of a first output or flush operation, the device 105 may perform a first uniformity correction (e.g., a first gain maps operation) for the first subset of pixels, output the first subset of pixels to a first LCR processing path, and writeback the first subset of pixels (e.g., the corrected first subset of pixels) to the first line buffer. As part of a second output or flush operation, the device 105 may perform a second uniformity correction (e.g., a second gain maps operation) for the second subset of pixels, output the second subset of pixels to a second LCR processing path and an interleaver, and pull the corrected first subset of pixels from the first line buffer to the interleaver.

As such, the device 105 may provide partially interleaved pixels to LCR processing paths (for channel comparison between left pixels, center pixels, and right pixels) and may use the interleaver to fully interleave the set of pixels for one or more LR processing paths. For example, the interleaver may feature a map and may interleave the first subset of pixels and the second subset of pixels in accordance with the map to obtain a fully interleaved set of pixels. The device 105, via the interleaver, may transmit or output the fully interleaved set of pixels to the one or more LR processing paths.

The techniques described herein may provide improvements in PDAF and device size. Further, the techniques described herein may provide benefits and enhancements to the operation of the devices 105. For example, by rearranging pixels into left or right channels and providing pixels associated with different levels of interleaving to different processing paths, the operational characteristics, such as power consumption, processor utilization (e.g., DSP, CPU, GPU, ISP processing utilization), and memory usage of the devices 105 may be reduced. The techniques described herein may also provide processing efficiency and area reduction to the devices 105 by reducing latency and quantity of components associated with processes related to PDAF.

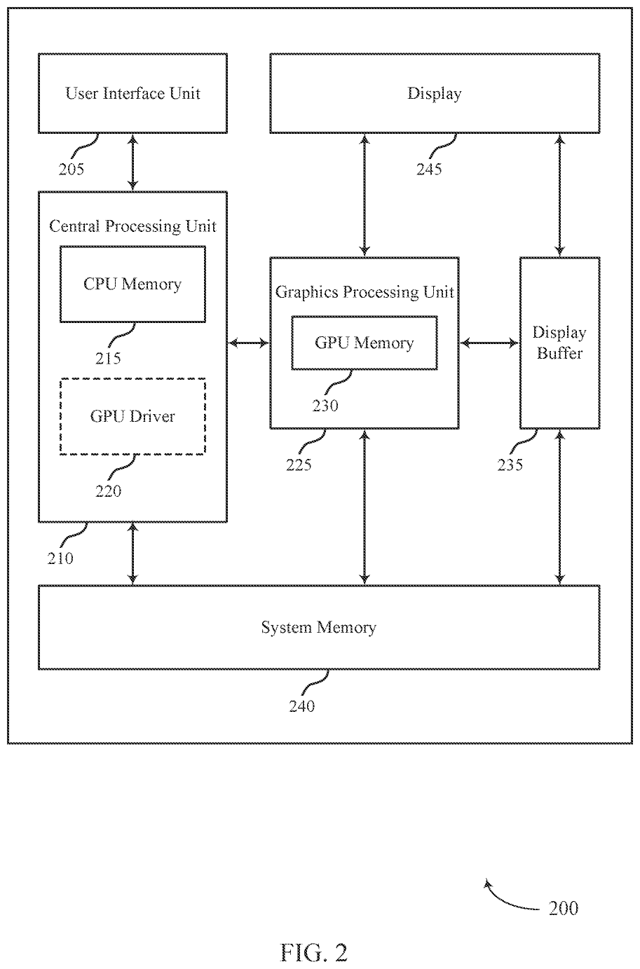

FIG. 2 illustrates an example of a device 200 that supports techniques for PDAF in accordance with aspects of the present disclosure. In the example of FIG. 2, device 200 includes a CPU 210 having CPU memory 215, a GPU 225 having GPU memory 230, a display 245, a display buffer 235 storing data associated with rendering, a user interface unit 205, and a system memory 240. For example, system memory 240 may store a GPU driver 220 (illustrated as being contained within CPU 210 as described herein) having a compiler, a GPU program, or a locally-compiled GPU program, among other examples. User interface unit 205, CPU 210, GPU 225, system memory 240, and display 245 may communicate with each other (e.g., using a system bus).

Examples of CPU 210 include, but are not limited to, a DSP, general purpose microprocessor, ASIC, FPGA, or other equivalent integrated or discrete logic circuitry. Although CPU 210 and GPU 225 are illustrated as separate units in the example of FIG. 2, in some examples, CPU 210 and GPU 225 may be integrated into a single unit. CPU 210 may execute one or more software applications. Examples of the applications may include operating systems, word processors, web browsers, e-mail applications, spreadsheets, video games, audio or video capture, playback or editing applications, or other such applications that initiate the generation of image data to be presented via display 245. As illustrated, CPU 210 may include CPU memory 215. For example, CPU memory 215 may represent on-chip storage or memory used in executing machine or object code. CPU memory 215 may include one or more volatile or non-volatile memories or storage devices, such as flash memory, a magnetic data media, an optical storage media, etc. CPU 210 may be able to read values from or write values to CPU memory 215 more quickly than reading values from or writing values to system memory 240, which may be accessed, e.g., over a system bus.

GPU 225 may represent one or more dedicated processors for performing graphical operations. That is, for example, GPU 225 may be a dedicated hardware unit having fixed function and programmable components for rendering graphics and executing GPU applications. GPU 225 may also include a DSP, a general purpose microprocessor, an ASIC, an FPGA, or other equivalent integrated or discrete logic circuitry. GPU 225 may be built with a highly-parallel structure that provides more efficient processing of complex graphic-related operations than CPU 210. For example, GPU 225 may include a plurality of processing elements that are configured to operate on multiple vertices or pixels in a parallel manner. The highly parallel nature of GPU 225 may allow GPU 225 to generate graphic images (e.g., graphical user interfaces and two-dimensional or three-dimensional graphics scenes) for display 245 more quickly than CPU 210.

GPU 225 may, in some instances, be integrated into a motherboard of device 200. In other instances, GPU 225 may be present on a graphics card that is installed in a port in the motherboard of device 200 or may be otherwise incorporated within a peripheral device configured to interoperate with device 200. As illustrated, GPU 225 may include GPU memory 230. For example, GPU memory 230 may represent on-chip storage or memory used in executing machine or object code. GPU memory 230 may include one or more volatile or non-volatile memories or storage devices, such as flash memory, a magnetic data media, an optical storage media, etc. GPU 225 may be able to read values from or write values to GPU memory 230 more quickly than reading values from or writing values to system memory 240, which may be accessed, e.g., over a system bus. That is, GPU 225 may read data from and write data to GPU memory 230 without using the system bus to access off-chip memory. This operation may allow GPU 225 to operate in a more efficient manner by reducing a constraint for GPU 225 to read and write data via the system bus, which may experience heavy bus traffic.

Display 245 represents a unit capable of displaying video, images, text or any other type of data for consumption by a viewer. Display 245 may include a liquid-crystal display (LCD), a light emitting diode (LED) display, an organic LED (OLED), or an active-matrix OLED (AMOLED), among other examples. Display buffer 235 represents a memory or storage device dedicated to storing data for presentation of imagery, such as computer-generated graphics, still images, or video frames, among other examples for display 245. Display buffer 235 may represent a two-dimensional buffer that includes a plurality of storage locations. The number of storage locations within display buffer 235 may, in some cases, generally correspond to the number of pixels to be displayed on display 245. For example, if display 245 is configured to include 640×480 pixels, display buffer 235 may include 640×480 storage locations storing pixel color and intensity information, such as red, green, and blue pixel values, or other color values. Display buffer 235 may store the final pixel values for each of the pixels processed by GPU 225. Display 245 may retrieve the final pixel values from display buffer 235 and display the final image based on the pixel values stored in display buffer 235.

User interface unit 205 represents a unit with which a user may interact with or otherwise interface to communicate with other units of device 200, such as CPU 210. Examples of user interface unit 205 include, but are not limited to, a trackball, a mouse, a keyboard, and other types of input devices. User interface unit 205 may also be, or include, a touch screen and the touch screen may be incorporated as part of display 245.

System memory 240 may comprise one or more computer-readable storage media. Examples of system memory 240 include, but are not limited to, a RAM, static RAM (SRAM), dynamic RAM (DRAM), a ROM, an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor. System memory 240 may store program modules or instructions that are accessible for execution by CPU 210. Additionally, system memory 240 may store user applications and application surface data associated with the applications. System memory 240 may in some cases store information for use by or information generated by other components of device 200. For example, system memory 240 may act as a device memory for GPU 225 and may store data to be operated on by GPU 225 as well as data resulting from operations performed by GPU 225

In some examples, system memory 240 may include instructions that cause CPU 210 or GPU 225 to perform the functions ascribed to CPU 210 or GPU 225 in aspects of the present disclosure. System memory 240 may, in some examples, be considered as a non-transitory storage medium. The term “non-transitory” should not be interpreted to mean that system memory 240 is non-movable. As one example, system memory 240 may be removed from device 200 and moved to another device. As another example, a system memory substantially similar to system memory 240 may be inserted into device 200. In some examples, a non-transitory storage medium may store data that can, over time, change (e.g., in RAM).

System memory 240 may store a GPU driver 220 and compiler, a GPU program, and a locally-compiled GPU program. The GPU driver 220 may represent a computer program or executable code that provides an interface to access the GPU 225. CPU 210 may execute the GPU driver 220 or portions thereof to interface with GPU 225 and, for this reason, GPU driver 220 is shown in the example of FIG. 2 within CPU 210. GPU driver 220 may be accessible to programs or other executables executed by CPU 210, including the GPU program stored in system memory 240. Thus, when one of the software applications executing on CPU 210 involves graphics processing, CPU 210 may provide graphics commands and graphics data to GPU 225 for rendering to display 245 (e.g., via GPU driver 220).

In some cases, the GPU program may include code written in a high level (HL) programming language, e.g., using an application programming interface (API). Examples of APIs include Open Graphics Library (“OpenGL”), DirectX, Render-Man, WebGL, or any other public or proprietary standard graphics API. The instructions may also conform to so-called heterogeneous computing libraries, such as Open-Computing Language (“OpenCL”), DirectCompute, etc. In general, an API includes a predetermined, standardized set of commands that are executed by associated hardware. API commands allow a user to instruct hardware components of a GPU 225 to execute commands without user knowledge as to the specifics of the hardware components. In order to process the graphics rendering instructions, CPU 210 may issue one or more rendering commands to GPU 225 (e.g., through GPU driver 220) to cause GPU 225 to perform some or all of the rendering of the graphics data. In some examples, the graphics data to be rendered may include a list of graphics primitives (e.g., points, lines, triangles, quadrilaterals, etc.).

The GPU program stored in system memory 240 may invoke or otherwise include one or more functions provided by GPU driver 220. CPU 210 generally executes the program in which the GPU program is embedded and, upon encountering the GPU program, passes the GPU program to GPU driver 220. CPU 210 executes GPU driver 220 in this context to process the GPU program. That is, for example, GPU driver 220 may process the GPU program by compiling the GPU program into object or machine code executable by GPU 225. This object code may be referred to as a locally-compiled GPU program. In some examples, a compiler associated with GPU driver 220 may operate in real-time or near-real-time to compile the GPU program during the execution of the program in which the GPU program is embedded. For example, the compiler generally represents a unit that reduces HL instructions defined in accordance with a HL programming language to low-level (LL) instructions of a LL programming language. After compilation, these LL instructions are capable of being executed by specific types of processors or other types of hardware, such as FPGAs, ASICs, among other examples (including, but not limited to, CPU 210 and GPU 225).

In the example of FIG. 2, the compiler may receive the GPU program from CPU 210 when executing HL code that includes the GPU program. That is, a software application being executed by CPU 210 may invoke the GPU driver 220 (e.g., via a graphics API) to issue one or more commands to GPU 225 for rendering one or more graphics primitives into displayable graphics images. The compiler may compile the GPU program to generate the locally-compiled GPU program that conforms to a LL programming language. The compiler may then output the locally-compiled GPU program that includes the LL instructions. In some examples, the LL instructions may be provided to GPU 225 in the form a list of drawing primitives (e.g., triangles, rectangles, etc.).

The LL instructions (e.g., which may alternatively be referred to as primitive definitions) may include vertex specifications that specify one or more vertices associated with the primitives to be rendered. The vertex specifications may include positional coordinates for each vertex, and, in some instances, other attributes associated with the vertex, such as color coordinates, normal vectors, and texture coordinates. The primitive definitions may include primitive type information, scaling information, or rotation information, among other examples. Based on the instructions issued by the software application (e.g., the program in which the GPU program is embedded), GPU driver 220 may formulate one or more commands that specify one or more operations for GPU 225 to perform in order to render the primitive. When GPU 225 receives a command from CPU 210, it may decode the command and configure one or more processing elements to perform the specified operation and may output the rendered data to display buffer 235.

GPU 225 generally receives the locally-compiled GPU program, and then, in some instances, GPU 225 renders one or more images and outputs the rendered images to display buffer 235. For example, GPU 225 may generate a number of primitives to be displayed at display 245. Primitives may include one or more of a line (including curves, splines, etc.), a point, a circle, an ellipse, a polygon (e.g., a triangle), or any other two-dimensional primitive. The term “primitive” may also refer to three-dimensional primitives, such as cubes, cylinders, sphere, cone, pyramid, or torus, among other examples. Generally, the term “primitive” refers to any basic geometric shape or element capable of being rendered by GPU 225 for display as an image (or frame in the context of video data) via display 245. GPU 225 may transform primitives and other attributes (e.g., that define a color, texture, lighting, camera configuration, or other aspect) of the primitives into a so-called “world space” by applying one or more model transforms (which may also be specified in the state data). Once transformed, GPU 225 may apply a view transform for the active camera (which again may also be specified in the state data defining the camera) to transform the coordinates of the primitives and lights into the camera or eye space. GPU 225 may also perform vertex shading to render the appearance of the primitives in view of any active lights. GPU 225 may perform vertex shading in one or more of the above model, world, or view space.

Once the primitives are shaded, GPU 225 may perform projections to project the image into a canonical view volume. After transforming the model from the eye space to the canonical view volume, GPU 225 may perform clipping to remove any primitives that do not at least partially reside within the canonical view volume. That is, GPU 225 may remove any primitives that are not within the frame of the camera. GPU 225 may then map the coordinates of the primitives from the view volume to the screen space, effectively reducing the three-dimensional coordinates of the primitives to the two-dimensional coordinates of the screen. Given the transformed and projected vertices defining the primitives with their associated shading data, GPU 225 may then rasterize the primitives. Generally, rasterization may refer to the task of taking an image described in a vector graphics format and converting it to a raster image (e.g., a pixelated image) for output on a video display or for storage in a bitmap file format.

A GPU 225 may include a dedicated fast bin buffer (e.g., a fast memory buffer, such as GMEM, which may be referred to by GPU memory 230). As discussed herein, a rendering surface may be divided into bins. In some cases, the bin size is determined by format (e.g., pixel color and depth information) and render target resolution divided by the total amount of GMEM. The number of bins may vary based on device 200 hardware, target resolution size, and target display format. A rendering pass may draw (e.g., render, write, etc.) pixels into GMEM (e.g., with a high bandwidth that matches the capabilities of the GPU). The GPU 225 may then resolve the GMEM (e.g., burst write blended pixel values from the GMEM, as a single layer, to a display buffer 235 or a frame buffer in system memory 240). Such may be referred to as bin-based or tile-based rendering. When all bins are complete, the driver may swap buffers and start the binning process again for a next frame.

For example, GPU 225 may implement a tile-based architecture that renders an image or rendering target by breaking the image into multiple portions, referred to as tiles or bins. The bins may be sized based on the size of GPU memory 230 (e.g., which may alternatively be referred to herein as GMEM or a cache), the resolution of display 245, the color or Z precision of the render target, etc. When implementing tile-based rendering, GPU 225 may perform a binning pass and one or more rendering passes. For example, with respect to the binning pass, GPU 225 may process an entire image and sort rasterized primitives into bins.

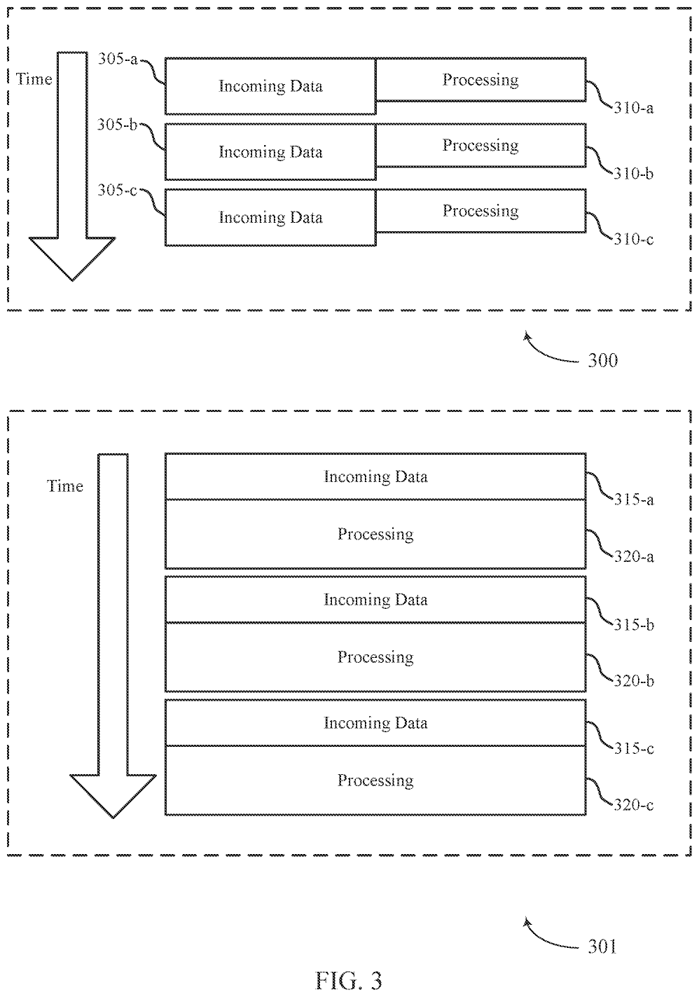

In some implementations, one or more components of the device 200 may employ techniques for PDAF that enable the device 200 to perform processing tasks related to PDAF more quickly and efficiently while reducing the size or area of the system memory 240 that is used for PDAF. For example, as a result of rearranging pixels into left and right channels and re-using a same set of one or more line buffers for multiple processing tasks, the device 200 may achieve an area reduction for one or more components while also improving results of the PDAF. Additional details relating to such a re-using of the same set of line buffers via multiple output or flush modes are illustrated and described in more detail herein, including with reference to FIGS. 3 through 13.

FIG. 3 illustrates example processing timelines 300 and 301 that support techniques for PDAF in accordance with aspects of the present disclosure. The processing timelines 300 and 301 may implement or be implemented to realize aspects of the media system 100. For example, one or more components associated with PDAF processing timelines 300 and 301 may employ different line buffer mapping modes for different input data rates and for different input data sizes.

Hardware design considerations may account for the rate and dimensions of input data (such as incoming data 305 or incoming data 315). For example, if input data is sent at a relatively constant rate, the hardware design may manage a double buffering mechanism. In such examples, previous chunks of input data may be processed in parallel to an incoming chunk of input data. As shown in the processing timeline 300, for example, a device may perform processing 310-a for previous data in parallel to receiving incoming data 305-a. The device may perform processing 310-b (e.g., for the incoming data 305-a received previously) in parallel to receiving incoming data 305-b. Similarly, the device may perform processing 310-c (e.g., for the incoming data 305-b received previously) in parallel to receiving incoming data 305-c.

Alternatively, if incoming data chunks are spaced out by idle blanking periods (e.g., a relatively or sufficiently long idle blanking period), hardware may use sequential processing during a blanking period. As shown in the processing timeline 301, for example, the device may receive incoming data 315-a and perform processing 320-a (e.g., for the incoming data 315-a) sequentially. Similarly, the device may receive incoming data 315-b and perform processing 320-b (e.g., for the incoming data 315-b) sequentially. Similarly, the device may receive incoming data 315-c and perform processing 320-c (e.g., for the incoming data 315-c) sequentially.

In some cases, a high diversity of PDAF patterns may challenge both approaches (e.g., both the processing timeline 300 and the processing timeline 301). For example, some sensors may send relatively large buffers with relatively long blanking while some other sensors may send relatively small buffers with a relatively short blanking period. As such, some hardware designs may use relatively large line buffers (to handle sensors sending large buffers) and may use double buffering (to handle sensors sending small buffers with short blanking). Such hardware designs, however, may result in a relatively large footprint (e.g., occupied area, as multiple sets of line buffers may be used). Alternatively, a hardware design may elect to support a subset of sensor inputs. For example, some hardware designs may elect to support sensors with small resolution (e.g., using a double buffering mechanism) while some other hardware designs may elect to support sensors with relatively large blanking between incoming lines (where such hardware designs may not support both).

In some implementations of the present disclosure, a device may re-map one or more internal memories in different configurations to support different line buffer mapping modes for different data input rates or sizes/dimensions. For example, the device may employ a double buffer to allow for intercepting of pixels from new block line in parallel to flushing or processing pixels from one or more previous block lines if the device detects or otherwise determines that a corresponding sensor is providing data with small resolution and with relatively short blanking. Further, the device may employ a single buffer to support same memories being mapped as a wider buffer to support higher resolutions (e.g., if the device detects or otherwise determines that a corresponding sensor is providing data with high resolution and with relatively long blanking).

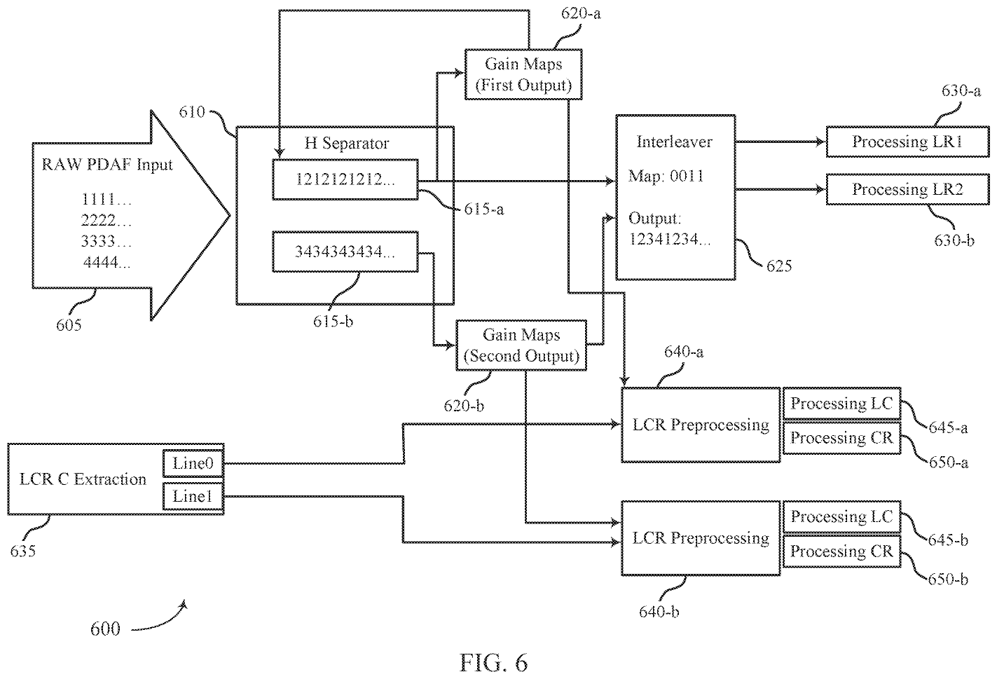

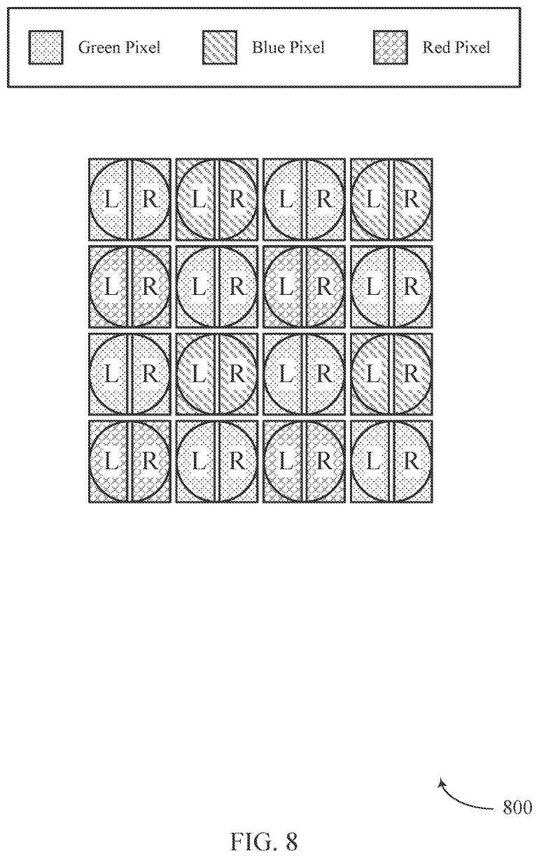

In some examples, the device may implement such a re-mapping of internal memories to support different line buffer mapping modes in one or more hardware blocks. For example, the device may implement the re-mapping in a horizontal separator block and an LCR extraction block, which may contribute to area shrink or reduction. Further, this re-mapping may combine with a mapping used for different flush modes including a single flush mode, a dual flush mode, or a hybrid flush mode. Additional details relating to various flush modes are described herein, including with reference to FIGS. 6 and 8.

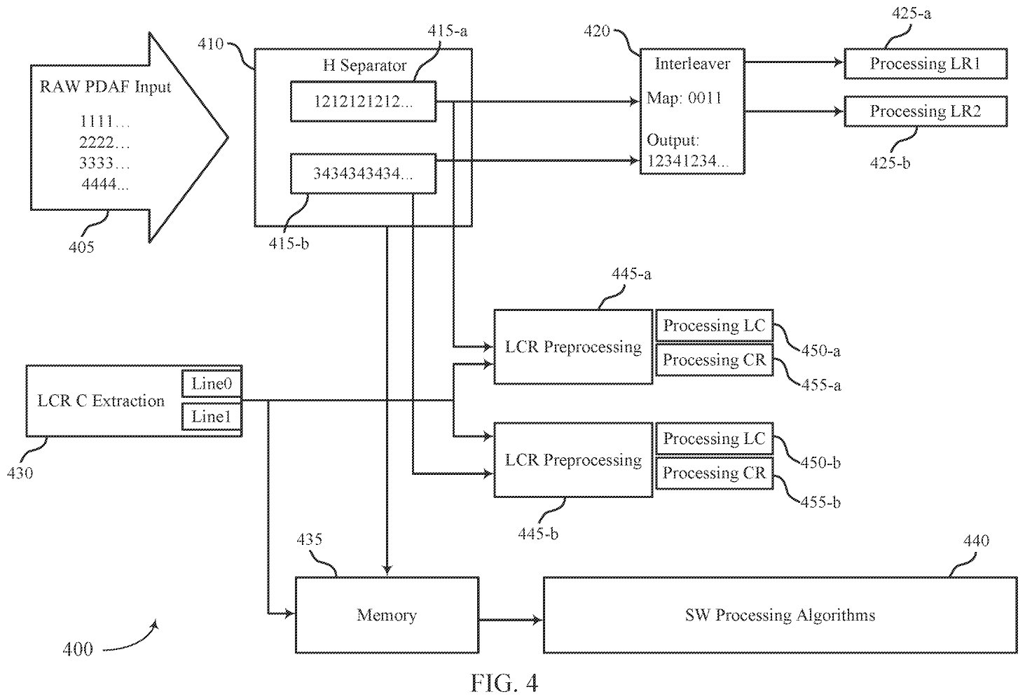

FIG. 4 illustrates an example of a processing diagram 400 that supports techniques for PDAF in accordance with aspects of the present disclosure. The processing diagram 400 may implement or be implemented to realize aspects of the media system 100. For example, the processing diagram 400 may be an example of a PDAF processing block as described herein. In some examples, the processing diagram 400 may support several output operations for providing PDAF input data 405 to various processing paths with different levels of interleaving.

For example, a device may receive the PDAF input data 405 (e.g., from a sensor). The PDAF input data 405 may include a number of PDAF pixels (which may include data from left and right pixels) and, in some examples, the PDAF pixels may be associated with a PDAF pattern. In such examples in which the PDAF input data 405 is associated with a PDAF pattern, the device may receive the PDAF input data 405 in accordance with the PDAF pattern. For example, the device may receive the PDAF input data 405 via a set of one or more data lines. In examples in which a repeating block includes four pixels, for instance, a first line may include a first pixel of a repeating pattern (e.g., illustrated as “1111 . . . ” in FIG. 4), a second line may include a second pixel of the repeating pattern (e.g., illustrated as “2222 . . . ” in FIG. 4), a third line may include a third pixel of the repeating pattern (e.g., illustrated as “3333 . . . ” in FIG. 4), and a fourth line may include a fourth pixel of the repeating pattern (e.g., illustrated as “4444 . . . ” in FIG. 4). In some examples, the first pixel of the repeating pattern may be a left pixel, the second pixel of the repeating pattern may be a right pixel, the third pixel of the repeating pattern may be a left pixel, and the fourth pixel of the repeating pattern may be a right pixel. The device may extract such pixels of the repeating pattern and, in some examples, may rearrange the pixels.

The device may perform the rearranging in several stages and, in some implementations, the hardware design may organize the several stages to support a re-using of a same set of pixels multiple times. For example, the device may re-use a same set of pixels to compare left and right and perform registration between the left and right channels and the device may perform the registration between left and right channels multiple times. For instance, the device may perform the registration between the left and right channels twice for different filtering, such as for reduced noise filtering and for non-reduced noise filtering (e.g., for more or maximum detail). As such, the device may obtain two results from the two registration operations based on the same LR channels. Additionally or alternatively, a same set of pixels may be re-used for left-to-center and center-to-right comparisons such that a same pixel is compared to other pixels multiple times. For example, for performing LCR, each pixel may be re-used three times as a result of performing left-to-right comparison, performing left-to-center comparison, and performing center-to-right comparison.

To implement the hardware efficiently, instead of receiving or selecting pixels (e.g., PDAF input data 405 pixels) sequentially and rearranging them into a main memory, the device may employ a horizontal separator 410 (shown as an H separator 410 in FIG. 4) to receive the pixels sequentially and may write the pixels into an internal buffer by (non-sequentially) rearranging the pixels. For example, the horizontal separator 410 may receive the first line of “1111 . . . ” pixels and may write pixels from the first line to first locations in a line buffer 415-a, leaving holes for second locations in the line buffer 415-a for pixels of the second line of “2222 . . . ” pixels. Accordingly, the horizontal separator 410 may receive the second line of “2222 . . . ” pixels and may write pixels from the second line to the second locations (e.g., the holes) in the line buffer 415-a. Similarly, the horizontal separator 410 may receive the third line of “3333 . . . ” pixels and may write pixels from the third line to first locations in a line buffer 415-b, leaving holes for second locations in the line buffer 415-b for pixels of the fourth line of “4444 . . . ” pixels. Accordingly, the horizontal separator 410 may receive the fourth line of “4444 . . . ” pixels and may write pixels from the fourth line to the second locations (e.g., the holes) in the line buffer 415-b.

As such, the horizontal separator 410 may perform some partial interleaving for LCR preprocessing paths 445. As shown in FIG. 4, the horizontal separator 410 may interleave the first pixel of the repeating pattern and the second pixel of the repeating pattern to obtain a “121212 . . . ” subset of pixels and may interleave the third pixel of the repeating pattern and the fourth pixel of the repeating pattern to obtain a “343434 . . . ” subset of pixels. Such a “121212 . . . ” subset of pixels may be referred to herein as a first subset of pixels and such a “343434 . . . ” subset of pixels may be referred to herein as a second subset of pixels. The horizontal separator may store the first subset of pixels in the line buffer 415-a and may store the second subset of pixels in the line buffer 415-b.

The performance or accuracy of the LCR preprocessing paths 445 may improve if such partial interleaving (or no interleaving) is used. As such, the device may output the first subset of pixels to an LCR preprocessing path 445-a and may output the second subset of pixels to an LCR preprocessing path 445-b. Further, although shown in FIG. 4 as using some partial interleaving, the LCR preprocessing paths 445 may use no interleaving. In such examples, the LCR preprocessing paths may receive the non-interleaved first line including the first pixel of the repeating pattern (e.g., “1111 . . . ”), the non-interleaved second line including the second pixel of the repeating pattern (e.g., “2222 . . . ”), and so on. As part of the LCR preprocessing path 445-a, the device may perform processing LC 450-a (e.g., a left-to-center comparison) and a processing CR 455-a (e.g., a center-to-right comparison). Similarly, as part of the LCR preprocessing path 445-b, the device may perform processing LC 450-b (e.g., a left-to-center comparison) and a processing CR 455-b (e.g., a center-to-right comparison). In some examples, the LCR preprocessing paths 445 may receive center pixels from an LCR center extraction 430 (shown as LCR C extraction in FIG. 4).

For example, the LCR center extraction 430 may extract a center or regular pixel and may enable a comparison between left pixels and center or regular pixels and between right pixels and center or regular pixels. As such, the device may have three channels and may perform autofocus using the comparison between the left pixels and the center or regular pixels or the comparison between the right pixels and the center or regular pixels, or both. In some examples, the horizontal separator 410 and the LCR center extraction 430 may write or output to a memory 435 (which may be an example of an internal memory). The memory 435 may write or output to or otherwise interface with one or more software processing algorithms 440.

In some implementations, the horizontal separator 410 may output the first subset of pixels and the second subset of pixels to an interleaver 420. The interleaver 420 may be associated with a configured map and may interleave the first subset of pixels and the second subset of pixels in accordance with the map. As shown in FIG. 4, the map may be ‘0011’, which may indicate that the interleaver 420 may pull a first two pixels from the line buffer 415-a (e.g., a line buffer 0) followed by a second two pixels from the line buffer 415-b (e.g., a line buffer 1). As such, the interleaver 420 may output a set of fully interleaved pixels “12341234 . . . ” for one or more (e.g., two) processing LR 425 paths (e.g., for left-to-right comparison). For example, the interleaver may output the set of fully interleaved pixels for processing LR1 425-a and for processing LR2 425-b. Both the processing LR1 425-a and the processing LR2 425-b may be examples of left-to-right comparisons.

The LCR preprocessing paths 445 may process two lines and, in some examples, may process each line separately (e.g., without interleaving), while the processing LR 425 may process one line. For example, the processing LR 425 may feature or be associated with two different processing paths that use same data. As such, the device may perform two outputs (or flushes without a clearing of the buffer) from the line buffers 415 to the LCR preprocessing paths 445. For example, the device may fill the line buffer 415-a and may output the filled line buffer 415-a to the LCR preprocessing path 445-a as part of a first output or flush operation. Similarly, the device may fill the line buffer 415-b and may output the filled line buffer 415-b to the LCR preprocessing path 445-b as part of a second output or flush operation.

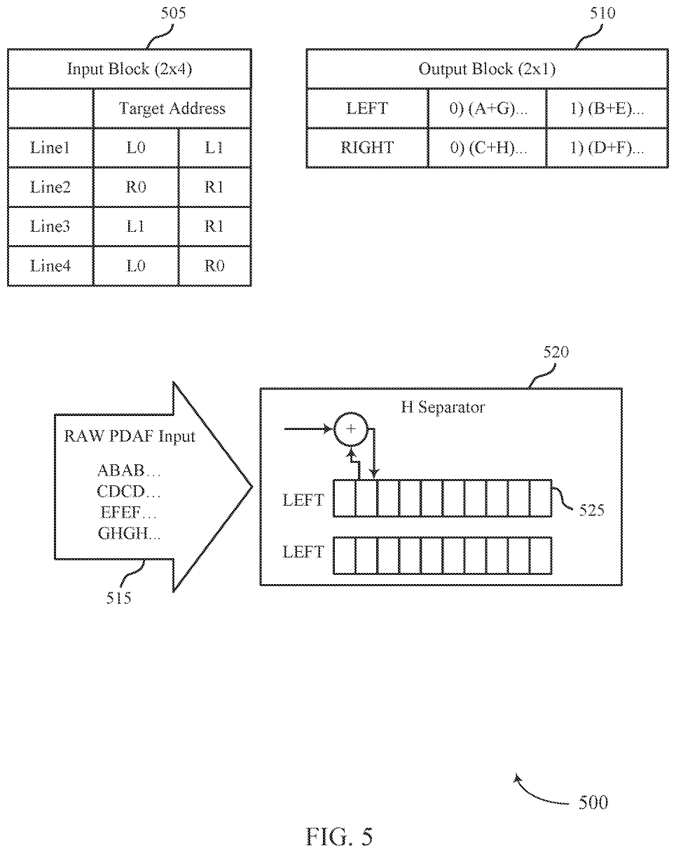

In some examples, the device may determine a PDAF parameter based on one or more outputs of the processing LR1 425-a, the processing LR2 425-b, the processing LC 450-a, the processing CR 455-a, the processing LC 450-b, and the processing CR 455-b. As such, in accordance with the processing diagram 400, the device may receive a set of pixels and may perform multiple processing tasks using the set of pixels with different levels of interleaving (or with different interleaving schemes) for each of the different processing tasks (without duplicating the line buffers 415) and may output the PDAF parameter as a result of the multiple processing tasks. As a result of using the same line buffers 415 multiple times, the device may achieve area reduction. Additional details relating to the management of the line buffers are described herein, including with reference to FIG. 5. Further, the processing diagram 400 illustrates example PDAF processing for one block line of a frame and the device may repeat the processes and operations shown by the processing diagram 400 for each block line of the frame.

FIG. 5 illustrates an example of a rearranging and binning diagram 500 that supports techniques for PDAF in accordance with aspects of the present disclosure. The rearranging and binning diagram 500 may implement or be implemented to realize aspects of the media system 100. For example, the rearranging and binning diagram 500 illustrates example PDAF buffer management for a line buffer 525, which may be an example of a line buffer 415 (as shown in FIG. 4), in a manner that saves area that would otherwise be occupied by memory in hardware designs that support PDAF for multiple, diverse PDAF patterns.

The rearranging and binning diagram 500 includes an input block 505, an output block 510, PDAF input data 515 (which may reflect the raw PDAF input corresponding to the input block 505), and a horizontal separator 520 (shown as H separator in FIG. 5). As shown in FIG. 5, the PDAF input data 515 may include a first line of “ABAB . . . ” pixels, a second line of “CDCD . . . ” pixels, a third line of “EFEF . . . ” pixels, and a fourth line of “GHGH . . . ” pixels. In some aspects, the horizontal separator 520 may be an example of a horizontal separator 410 (as shown in FIG. 4). In some examples, such as in examples in which the PDAF input data 515 is associated with a sparse PDAF pattern, the device may rearrange the PDAF input data 515 into the one or more line buffers 525 without binning down the rearranged pixels in the line buffers 525. In some other examples, such as in examples in which the PDAF input data 515 is associated with a full PDAF pattern, the device may rearrange the PDAF input data 515 into the one or more line buffers 525 and may bin the pixels down. For example, the device may take multiple lines (e.g., of a same block or of different blocks) and may sum them together. In other words, the device may take multiple pixels and sum the columns of multiple lines to obtain one line. Such a binning procedure may be referred to herein as vertical binning.

To support vertical binning, the device may use a line buffer 525 to accumulate a line and across several lines the device may sum the respective columns. As such, the device may support a read, modify/add, and write operation for each column to bin multiple lines into a single line buffer 525. For example, the device, when binning a next line to the line buffer 525, may read a current value of a location in the line buffer 525, modify the value of the location as a result of adding a pixel value of the next line that is being binned to the same location of the line buffer 525, and writeback the modified value to the location in the line buffer 525. In some aspects, such a binning may be referred to herein as a non-sequential read, add, writeback procedure. The device may bin any quantity of lines to a single line buffer 525.

As illustrated in FIG. 5, the input block 505, which may be associated with a block size of 2×4, may include a number of lines (e.g., four lines) of left channel pixels, right channel pixels, or a combination of left channel and right pixel channels. For example, a line1 may include pixels having target addresses to L0 and L1, a line2 may include pixels having target addresses to R0 and R1, a line3 may include pixels having target addresses to L1 and R1, and a line4 may include pixels having target addresses to L0 and R0. In some aspects, the input may be sequential and the internal binning may include random access read, add, writeback. The output block 510, which may be associated with a block size of 2×1, may illustrate a first column (e.g., a column 0) and a second column (e.g., a column 1) for a left channel and may illustrate a first column (e.g., a column 0) and a second column (e.g., a column 1) for a right channel. The first column of the left channel may include a pixel value corresponding to A+G and the second column of the left channel may include a pixel value corresponding to B+E. The first column of the right channel may include a pixel value corresponding to C+H and the second column of the right channel may include a pixel value corresponding to D+F.

Accordingly, a same processing block may include line buffers 525 that are able to provide different levels of interleaving to different processing paths and may additionally support such a rearranging or binning, which may provide flexibility for handling different types of PDAF patterns without adding more components or processing blocks. As such, in accordance with some implementations of the present disclosure, one hardware block may support a rearranging of pixels or a binning of pixels, or both, using a single set of line buffers 525, which may result in area reduction, a smaller footprint, and more efficient processing.

FIG. 6 illustrates an example of a processing diagram 600 that supports techniques for PDAF in accordance with aspects of the present disclosure. The processing diagram 600 may implement or be implemented to realize aspects of the media system 100. For example, the processing diagram 600 may be an example of a PDAF processing block as described herein. In some examples, the processing diagram 600 may support several output operations for providing PDAF input data 605 to various processing paths with different levels of interleaving and as part of different output operations to support efficient uniformity corrections.

For example, a device may receive the PDAF input data 605 (e.g., from a sensor). In some examples, the device may receive the PDAF input data 605 as a number of lines. A first line may include a first pixel of a repeating pattern (e.g., illustrated as “1111 . . . ” in FIG. 6), a second line may include a second pixel of the repeating pattern (e.g., illustrated as “2222 . . . ” in FIG. 6), a third line may include a third pixel of the repeating pattern (e.g., illustrated as “3333 . . . ” in FIG. 6), and a fourth line may include a fourth pixel of the repeating pattern (e.g., illustrated as “4444 . . . ” in FIG. 6). In some examples, the first pixel of the repeating pattern may be a left pixel, the second pixel of the repeating pattern may be a right pixel, the third pixel of the repeating pattern may be a left pixel, and the fourth pixel of the repeating pattern may be a right pixel.

The device may extract such pixels of the repeating pattern and, in some examples, may rearrange or bin the pixels into a set of line buffers 615, such as a line buffer 615-a and a line buffer 615-b in a horizontal separator 610. The device may store a first subset of pixels in the line buffer 615-a and may store a second subset of pixels in the line buffer 615-b. In some implementations, the device may perform multiple output operations from the line buffers 615 (e.g., flush operations without clearing the associated line buffers 615) to output the first subset of pixels and the second subset of pixels to various pixel channels or processing paths with different levels of interleaving and with a uniformity correction (e.g., a gain maps correction 620).

For example, the device may perform a first output operation to output, from the line buffer 615-a, the first subset of pixels to an LCR preprocessing path 640-a (e.g., a first set of pixel channels). As part of the first output operation, the device may perform a gain maps correction 620-a (e.g., a first uniformity correction) on the first subset of pixels and may output the corrected pixels to the LCR preprocessing path 640-a and may write the corrected pixels back to the line buffer 615-a. As such, the device may perform the gain maps correction 620-a on the first subset of pixels and provide the first subset of pixels to the LCR preprocessing path 640-a while storing the corrected first subset of pixels in the same line buffer 615-a (e.g., without losing the corrected subset of pixels and without adding another line buffer). In some aspects, the first output operation may be referred to herein as a first flush operation for the line buffer 615-a without a clearing of the line buffer 615-a.

As a result of performing the first output operation, the device may perform a second output operation to output, from the line buffer 615-b, the second subset of pixels to an LCR preprocessing path 640-b (e.g., a second set of pixel channels) and an interleaver 625. As part of the second output operation, the device may perform a gain maps correction 620-b (e.g., a second uniformity correction) on the second subset of pixels and may output the corrected pixels to the LCR preprocessing path 640-b and to the interleaver 625. Further, and also as part of the second output operation, the device may pull the corrected first subset of pixels that are stored in the line buffer 615-a to the interleaver 625. As such, the device may efficiently provide the first subset of pixels and the second subset of pixels, with gain maps or uniformity correction, to their respective LCR preprocessing paths 640 and to the interleaver 625. In some aspects, the second output operation may be referred to herein as a second flush operation for the line buffer 615-a or the line buffer 615-b without a clearing of the line buffer 615-a or the line buffer 615-b.

In some examples, and as a result of performing the described first output operation and second operation, the device may avoid performing a gain maps or uniformity correction on a same set of pixels multiple times, which may improve processing efficiency without increasing memory space. In other words, it would be unnecessary to duplicate a processing block, which may save area and power. In some examples, the same gain maps correction block works twice (as part of each output operation) such that a same block may toggle both the gain maps correction 620-a and the gain maps correction 620-b.

As described in more detail with reference to FIG. 6, the device may process the first subset of pixels (e.g., the corrected first subset of pixels) via the LCR preprocessing path 640-a based on performing processing LC 645-a and processing CR 650-a and may process the second subset of pixels (e.g., the corrected second subset of pixels) via the LCR preprocessing path 640-b based on performing processing LC 645-b and processing CR 650-b. In some examples, the device may receive center pixel information from an LCR center extraction 635 and pass the center pixel information to the LCR preprocessing paths 640.

Further, and as a result of performing the second output operation, the device may use the interleaver 625 to interleave the corrected first subset of pixels and the corrected second subset of pixels. The interleaver 625 may output the fully interleaved corrected set of pixels (e.g., “12341234 . . . ”) to one more processing LR 630 paths. For example, the interleaver 625 may output the set of fully interleaved pixels to a processing LR1 630-a and to a processing LR2 630-b. Additional details relating to the processing tasks associated with the processing LR1 630-a and the processing LR2 630-b are described herein.

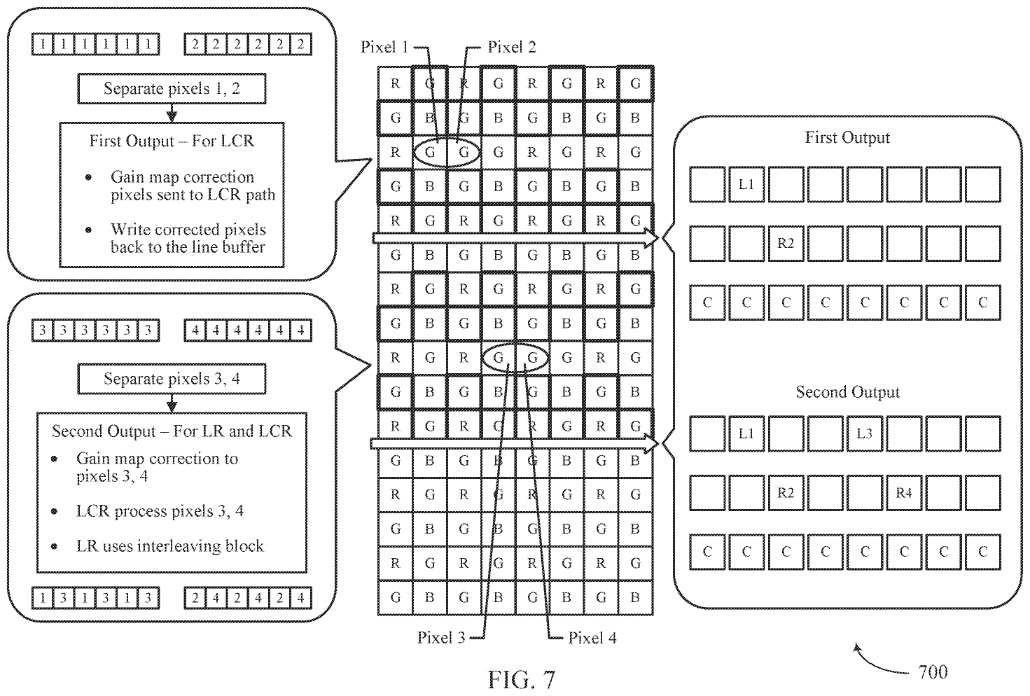

FIG. 7 illustrates an example of a hybrid output 700 that supports techniques for PDAF in accordance with aspects of the present disclosure. The hybrid output 700 may implement or be implemented to realize aspects of the media system 100. For example, the hybrid output 700 may be an example of a hybrid output operation or a hybrid flush operation (without buffer clearing) that a device may perform to output a set of pixels to multiple processing paths with correction and varying levels of interleaving (or varying interleaving schemes).

The device may select a first two pixels including a pixel 1 and a pixel 2 and may separate the pixels 1, 2. The device may perform a first output operation (e.g., a first flush operation) and, as part of the first output operation, may send gain map correction pixels to an LCR path (e.g., a first LCR path) and may write the corrected pixels back to the line buffer. Further, the device may select a second two pixels including a pixel 3 and a pixel 4 and may separate pixels 3, 4 (e.g., into proper locations in LRLB). The device may perform a second output operation (e.g., a second output operation) and, as part of the second output operation, may perform a gain map correction to pixels 3, 4, LCR process pixels 3, 4, and LR may use the interleaving block to pull from the line buffer storing the corrected pixels 1, 2 as well as the gain map correction pixels 3, 4. In other words, the LR may use the interleaving block to pull pixels from both the first output/flush and the second output/flush. In some examples, the first output/flush may be exclusively for LCR and the second output/flush may be for both LR and LCR.

Each output operation may be illustrated in FIG. 7 by an arrow and each output operation may be associated with a different output. For example, the first output operation may be associated with a first output and the second output operation may be associated with a second output. Further, for each output or flush, the center line may have full resolution and, in some examples (and as illustrated in FIG. 7), the center line may be denser than L/R lines (e.g., 8 times denser). The described techniques may be implemented in various use cases featuring diverse PDAF patterns, as described in more detail herein.

FIG. 8 illustrates an example of a 2PD PDAF pattern 800 that supports techniques for PDAF in accordance with aspects of the present disclosure. A device may implement the techniques and hardware design described herein to support PDAF processing for the 2PD PDAF pattern 800. For image processing associated with the 2PD PDAF pattern 800, a sensor (e.g., a T2 sensor) may downscale L/R channels 2×4 as compared to some other filtering (e.g., a Bayer filter). A T2 buffer size may be associated with dimension of W×(H/4) and, to reduce horizontal blanking, the sensor may split each phase-detection line into 4 lines. A line extractor and the line extractor may skip some of the header/footer for each of the 4 lines. A horizontal separator, which may be an example of horizontal separators described herein, may receive a repeating input block 2×1 and may separate the input block to L/R line buffers. The device may also use the horizontal separator for additional vertical binning of 8 phase-detection lines to reduce noise/power. A sum of absolute differences (SAD) block may output 48 LR phases and a preprocessed block may output before IIR for phase-detection network (PDnet).

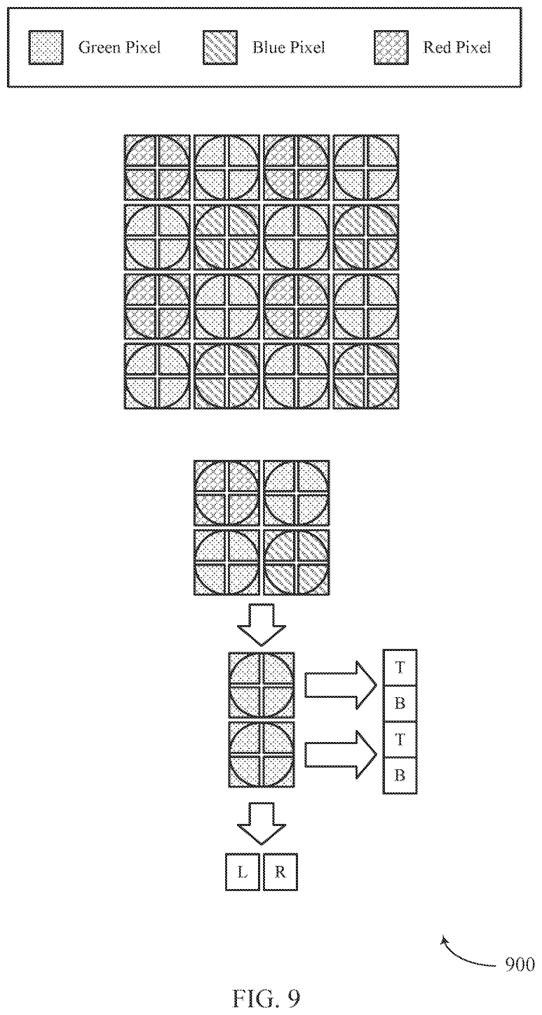

FIG. 9 illustrates an example of a QPD PDAF pattern 900 that supports techniques for PDAF in accordance with aspects of the present disclosure. A device may implement the techniques and hardware design described herein to support PDAF processing for the QPD PDAF pattern 900. For image processing associated with the QPD PDAF pattern 900, a sensor (e.g., a T2 sensor) may feature a horizontal path and a vertical path. The horizontal path may skip the vertical pixels and continue (same as 2PD). The vertical path may extract the vertical pixels, apply vertical gain maps, perform horizontal binning by a factor (e.g., 8) to reduce bandwidth and software processing load, and multiplexes to LCR output.

Another sensor (e.g., a T3 sensor) may also feature a horizontal path and a vertical path. The horizontal path may feature a pixel extractor to extract all green pixels with a dimension of W×(H×2). The horizontal path may also include a pixel separator featuring a map of 2×4 to single binned L and R pixels and, additionally, for binning 4 input blocks. The horizontal path of the T3 sensor may continue like the T2 sensor. The vertical path may feature a pixel separator that maps every 2×2 to top/bottom (T/B), performs horizontal binning of all T/B pixels, and multiplexes to LCR output. In some examples, a camera serial interface decoder (CSID) traffic concern may arise in which CSID to PDAF traffic may include all pixels, which may become a challenge. To reduce bandwidth to be more manageable, the device may add CSID binning options. For example, the device may bin green or all pixels of same directions (e.g., such that 4×4/6×6/8×8 turns to 2×2).

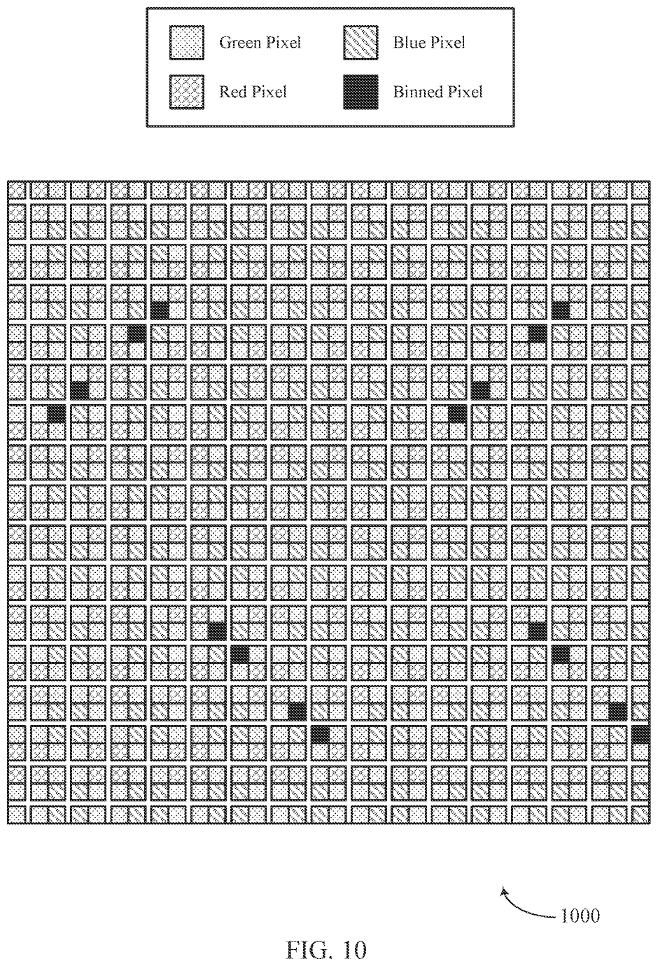

FIG. 10 illustrates an example of a QCFA PDAF pattern 1000 that supports techniques for PDAF in accordance with aspects of the present disclosure. A device may implement the techniques and hardware design described herein to support PDAF processing for the QCFA PDAF pattern 1000. For image processing associated with the QCFA PDAF pattern 1000, a horizontal path may include a pixel extractor that exclusively receives phase-detection pixels. In such examples, an output block size may be 2×8. The horizontal path may include a pixel separator to bin diagonal pairs (e.g., every diagonal pair) by mapping two lines into a same x coordinate. An LCR path may feature a dual flush LCR or a single flush LR, or both. A PDnet may include an RDI buffer (T2) and up to 2 of a preprocessed output, an LCR output, and a vertical output.

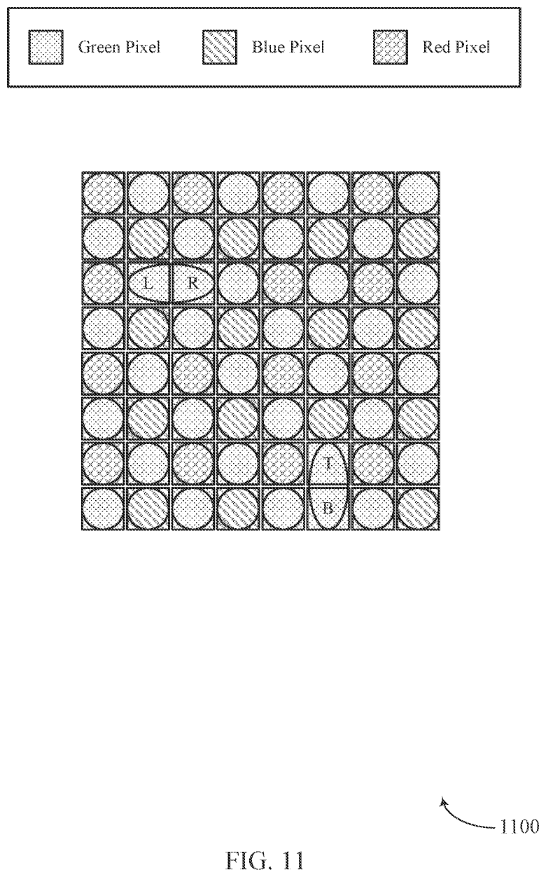

FIG. 11 illustrates an example of a sparse horizontal and vertical PDAF pattern 1100 that supports techniques for PDAF in accordance with aspects of the present disclosure. A device may implement the techniques and hardware design described herein to support PDAF processing for the sparse horizontal and vertical PDAF pattern 1100. For image processing associated with the sparse horizontal and vertical PDAF pattern 1100, a device may use a CSID/extractor to shape pixels. For example, after extractor, pixels may be in a shape of: L R, T, B. A challenge that may arise is that extracted block output lines may not have a same width. As such, the device may add two dummy pixels to support a consistent output block of 2×3: L R, T X, B X. In some examples, the dummy X pixels may not be intercepted by the pixel separator. A horizontal path may separate L/R pixels and continue like other sparse cases. A vertical path may output to a preprocessed or LCR output. An LCR may feature a single flush.

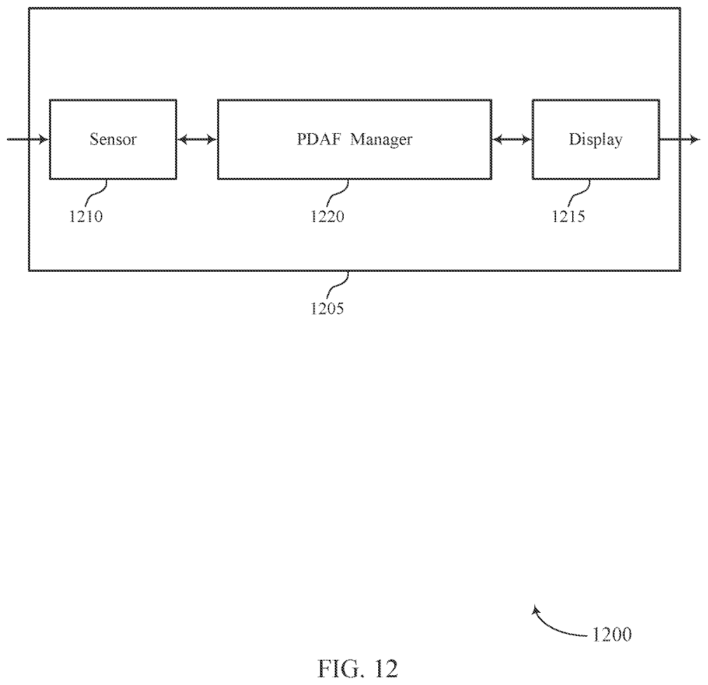

FIG. 12 shows a block diagram 1200 of a device 1205 that supports techniques for PDAF in accordance with aspects of the present disclosure. The device 1205 may be an example of aspects of a device 105 as described herein. The device 1205 may include a sensor 1210, a display 1215, and a PDAF manager 1220. The device 1205 may also include a processor. Each of these components may be in communication with one another (e.g., via one or more buses).

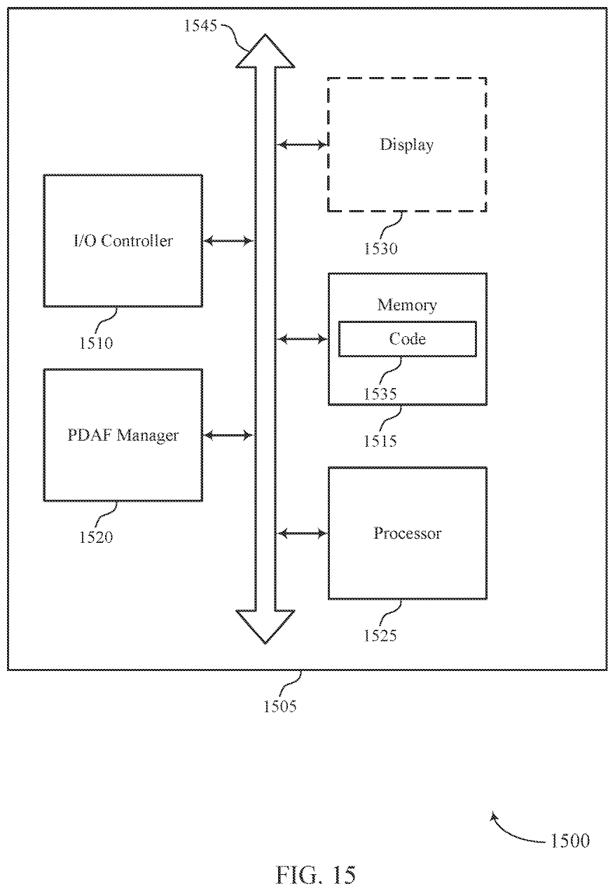

The one or more sensors 1210 (e.g., image sensors, cameras, etc.) may receive information (e.g., light, for example, visible light or invisible light), which may be passed on to other components of the device 1205. In some cases, the sensors 1210 may be an example of aspects of the I/O controller 1510 described with reference to FIG. 15. A sensor 1210 may utilize one or more photosensitive elements that have a sensitivity to a spectrum of electromagnetic radiation to receive information (e.g., a sensor 1210 may be configured or tuned to receive a pixel intensity value, red green blue (RGB) values, infrared (IR) light values, near-IR light values, ultraviolet (UV) light values of a pixel, etc.). The information may then be passed on to other components of the device 1205.

Display 1215 may display content generated by other components of the device. Display 1215 may be an example of display 1530 as described with reference to FIG. 15. In some examples, display 1530 may be connected with a display buffer which stores rendered data until an image is ready to be displayed (e.g., as described with reference to FIG. 15). The display 1215 may illuminate according to signals or information generated by other components of the device 1205. For example, the display 1215 may receive display information (e.g., pixel mappings, display adjustments) from sensor 1210, and may illuminate accordingly. The display 1215 may represent a unit capable of displaying video, images, text or any other type of data for consumption by a viewer.

The display 1215 may include a liquid-crystal display (LCD), a light emitting diode (LED) display, an organic LED (OLED), or an active-matrix OLED (AMOLED), among other examples. In some cases, display 1215 and an I/O controller (e.g., I/O controller 1510) may be or represent aspects of a same component (e.g., a touchscreen) of the device 1205. The display 1215 may be any suitable display or screen allowing for user interaction or allowing for presentation of information (such as captured images and video) for viewing by a user. In some aspects, the display 1215 may be a touch-sensitive display. In some cases, the display 1215 may display images captured by sensors, where the displayed images that are captured by sensors may depend on the configuration of light sources and active sensors by the PDAF manager 1220.

The PDAF manager 1220, the sensor 1210, the display 1215, or various combinations thereof or various components thereof may be examples of means for performing various aspects of techniques for PDAF as described herein. For example, the PDAF manager 1220, the sensor 1210, the display 1215, or various combinations or components thereof may support a method for performing one or more of the functions described herein.

In some examples, the PDAF manager 1220, the sensor 1210, the display 1215, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the PDAF manager 1220, the sensor 1210, the display 1215, or various combinations or components thereof may be implemented in code (e.g., as communications management software or firmware) executed by a processor. If implemented in code executed by a processor, the functions of the PDAF manager 1220, the sensor 1210, the display 1215, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the PDAF manager 1220 may be configured to perform various operations (e.g., receiving, monitoring, transmitting) using or otherwise in cooperation with the sensor 1210, the display 1215, or both. For example, the PDAF manager 1220 may receive information from the sensor 1210, send information to the display 1215, or be integrated in combination with the sensor 1210, the display 1215, or both to receive information, transmit information, or perform various other operations as described herein.

The PDAF manager 1220 may support performing PDAF at the device 1405 in accordance with examples as disclosed herein. For example, the PDAF manager 1220 may be configured as or otherwise support a means for selecting a first subset of pixels of a set of pixels associated with a frame and a second subset of pixels of the set of pixels associated with the frame, each of the first subset of pixels and the second subset of pixels including at least two pixels. The PDAF manager 1220 may be configured as or otherwise support a means for performing a first output operation by outputting, from a first line buffer, the first subset of pixels to a first set of pixel channels. The PDAF manager 1220 may be configured as or otherwise support a means for performing a second output operation by outputting, from a second line buffer, the second subset of pixels to a second set of pixel channels and an interleaver. The PDAF manager 1220 may be configured as or otherwise support a means for outputting a PDAF parameter associated with the frame based on the first output operation and the second output operation.

By including or configuring the PDAF manager 1220 in accordance with examples as described herein, the device 1205 (e.g., a processor controlling or otherwise coupled to the sensor 1210, the display 1215, the PDAF manager 1220, or a combination thereof) may support techniques for reduced processing, reduced power consumption, and more efficient utilization of communication resources.

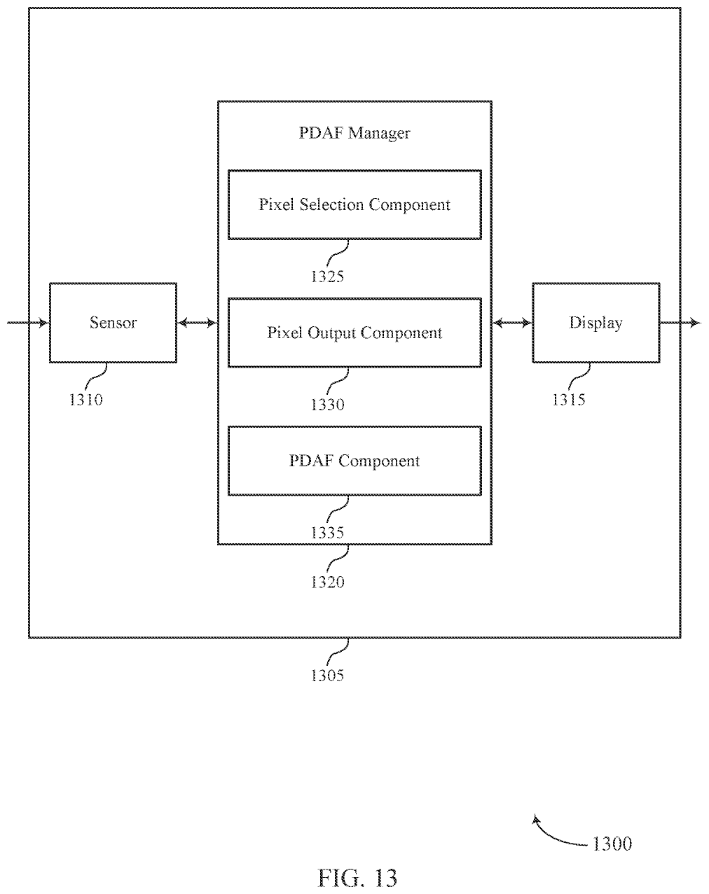

FIG. 13 shows a block diagram 1300 of a device 1305 that supports techniques for PDAF in accordance with aspects of the present disclosure. The device 1305 may be an example of aspects of a device 1205 or a device 105 as described herein. The device 1305 may include a sensor 1310, a display 1315, and a PDAF manager 1320. The device 1305 may also include a processor. Each of these components may be in communication with one another (e.g., via one or more buses).

The one or more sensors 1310 (e.g., image sensors, cameras, etc.) may receive information (e.g., light, for example, visible light or invisible light), which may be passed on to other components of the device 1305. In some cases, the sensors 1310 may be an example of aspects of the I/O controller 1510 described with reference to FIG. 15. A sensor 1310 may utilize one or more photosensitive elements that have a sensitivity to a spectrum of electromagnetic radiation to receive information (e.g., a sensor 1310 may be configured or tuned to receive a pixel intensity value, RGB values, IR light values, near-IR light values, UV light values of a pixel, etc.). The information may then be passed on to other components of the device 1305.

Display 1315 may display content generated by other components of the device. Display 1315 may be an example of display 1530 as described with reference to FIG. 15. In some examples, the display 1315 may be connected with a display buffer which stores rendered data until an image is ready to be displayed (e.g., as described with reference to FIG. 15). The display 1315 may illuminate according to signals or information generated by other components of the device 1305. For example, the display 1315 may receive display information (e.g., pixel mappings, display adjustments) from sensor 1310, and may illuminate accordingly. The display 1315 may represent a unit capable of displaying video, images, text or any other type of data for consumption by a viewer.

The display 1315 may include an LCD, an LED display, an OLED, or an AMOLED, among other examples. In some cases, the display 1315 and an I/O controller (e.g., the I/O controller 1510) may be or represent aspects of a same component (e.g., a touchscreen) of the device 1305. The display 1315 may be any suitable display or screen allowing for user interaction or allowing for presentation of information (such as captured images and video) for viewing by a user. In some aspects, the display 1315 may be a touch-sensitive display. In some cases, the display 1315 may display images captured by sensors, where the displayed images that are captured by sensors may depend on the configuration of light sources and active sensors by the PDAF manager 1320.

The device 1305, or various components thereof, may be an example of means for performing various aspects of techniques for PDAF as described herein. For example, the PDAF manager 1320 may include a pixel selection component 1325, a pixel output component 1330, a PDAF component 1335, or any combination thereof. The PDAF manager 1320 may be an example of aspects of a PDAF manager 1220 as described herein. In some examples, the PDAF manager 1320, or various components thereof, may be configured to perform various operations (e.g., receiving, monitoring, transmitting) using or otherwise in cooperation with the sensor 1310, the display 1315, or both. For example, the PDAF manager 1320 may receive information from the sensor 1310, send information to the display 1315, or be integrated in combination with the sensor 1310, the display 1315, or both to receive information, transmit information, or perform various other operations as described herein.

The PDAF manager 1320 may support performing PDAF at the device 1505 in accordance with examples as disclosed herein. The pixel selection component 1325 may be configured as or otherwise support a means for selecting a first subset of pixels of a set of pixels associated with a frame and a second subset of pixels of the set of pixels associated with the frame, each of the first subset of pixels and the second subset of pixels including at least two pixels. The pixel output component 1330 may be configured as or otherwise support a means for performing a first output operation by outputting, from a first line buffer, the first subset of pixels to a first set of pixel channels. The pixel output component 1330 may be configured as or otherwise support a means for performing a second output operation by outputting, from a second line buffer, the second subset of pixels to a second set of pixel channels and an interleaver. The PDAF component 1335 may be configured as or otherwise support a means for outputting a PDAF parameter associated with the frame based on the first output operation and the second output operation.

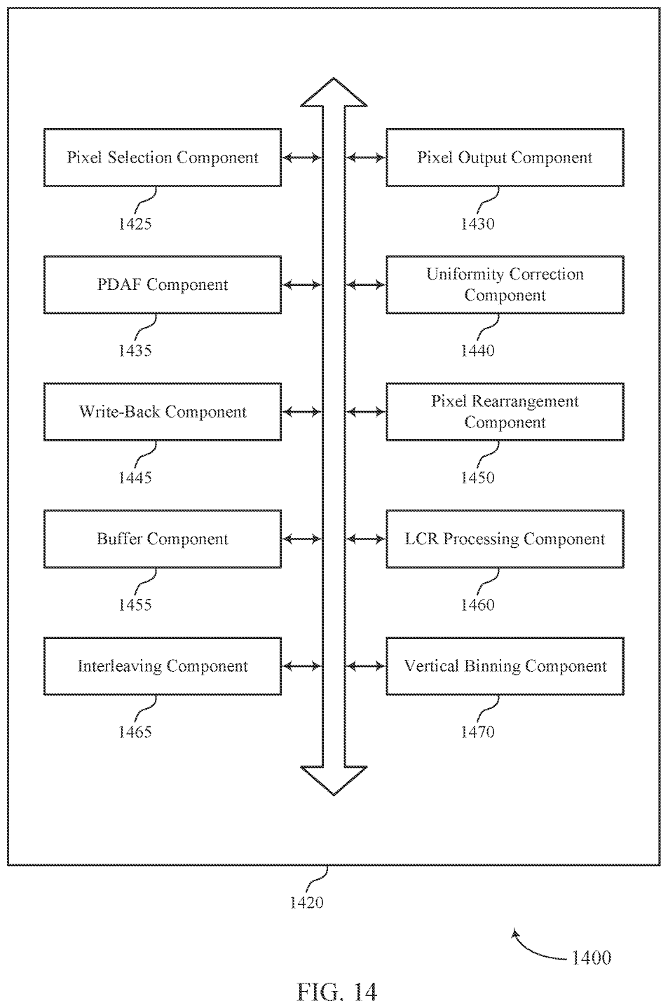

FIG. 14 shows a block diagram 1400 of a PDAF manager 1420 that supports techniques for PDAF in accordance with aspects of the present disclosure. The PDAF manager 1420 may be an example of aspects of a PDAF manager 1220, a PDAF manager 1320, or both, as described herein. The PDAF manager 1420, or various components thereof, may be an example of means for performing various aspects of techniques for PDAF as described herein. For example, the PDAF manager 1420 may include a pixel selection component 1425, a pixel output component 1430, a PDAF component 1435, a uniformity correction component 1440, a writeback component 1445, a pixel rearrangement component 1450, a buffer component 1455, an LCR processing component 1460, an interleaving component 1465, a vertical binning component 1470, or any combination thereof. Each of these components may communicate, directly or indirectly, with one another (e.g., via one or more buses).

The PDAF manager 1420 may support performing PDAF at a device in accordance with examples as disclosed herein. The pixel selection component 1425 may be configured as or otherwise support a means for selecting a first subset of pixels of a set of pixels associated with a frame and a second subset of pixels of the set of pixels associated with the frame. Each of the first subset of pixels and the second subset of pixels including at least two pixels. The pixel output component 1430 may be configured as or otherwise support a means for performing a first output operation by outputting, from a first line buffer, the first subset of pixels to a first set of pixel channels. In some examples, the pixel output component 1430 may be configured as or otherwise support a means for performing a second output operation by outputting, from a second line buffer, the second subset of pixels to a second set of pixel channels and an interleaver. The PDAF component 1435 may be configured as or otherwise support a means for outputting a PDAF parameter associated with the frame based on the first output operation and the second output operation.

In some examples, the uniformity correction component 1440 may be configured as or otherwise support a means for performing a first uniformity correction on the first subset of pixels to obtain a corrected first subset of pixels. In some examples, outputting the first subset of pixels to the first set of pixel channels includes outputting the corrected first subset of pixels. In some examples, the writeback component 1445 may be configured as or otherwise support a means for writing, to the first line buffer, the corrected first subset of pixels. In some examples, the uniformity correction component 1440 may be configured as or otherwise support a means for performing a second uniformity correction on the second subset of pixels to obtain a corrected second subset of pixels. In some examples, outputting the second subset of pixels to the second set of pixel channels and the interleaver includes outputting the corrected second subset of pixels.

In some examples, the pixel rearrangement component 1450 may be configured as or otherwise support a means for rearranging the set of pixels into the first subset of pixels and the second subset of pixels. In some examples, pixels of the first subset of pixels are rearranged to locations in the first line buffer and pixels of the second subset of pixels are rearranged to locations in the second line buffer. In some examples, the buffer component 1455 may be configured as or otherwise support a means for storing the first subset of pixels in the first line buffer and the second subset of pixels in the second line buffer based on the rearranging.

In some examples, to support rearranging the set of pixels into the first subset of pixels and the second subset of pixels, the pixel rearrangement component 1450 may be configured as or otherwise support a means for rearranging a first pixel of the set of pixels to a first location in the first line buffer and rearranging a second pixel of the set of pixels to a second location in the second line buffer. In some examples, to support rearranging the set of pixels into the first subset of pixels and the second subset of pixels, the vertical binning component 1470 may be configured as or otherwise support a means for performing a first vertical binning operation for the first pixel at the first location in the first line buffer. In some examples, to support rearranging the set of pixels into the first subset of pixels and the second subset of pixels, the vertical binning component 1470 may be configured as or otherwise support a means for performing a second vertical binning operation for the second pixel at the second location in the second line buffer.

In some examples, to support performing the first vertical binning operation, the vertical binning component 1470 may be configured as or otherwise support a means for reading a value of the first location in the first line buffer. In some examples, to support performing the first vertical binning operation, the vertical binning component 1470 may be configured as or otherwise support a means for adding a first value corresponding to the first pixel to the value of the first location in the first line buffer. In some examples, to support performing the first vertical binning operation, the vertical binning component 1470 may be configured as or otherwise support a means for writing, to the first location in the first line buffer, a first sum value based on adding the first value corresponding to the first pixel to the value of the first location in the first line buffer.

In some examples, to support performing the second vertical binning operation, the vertical binning component 1470 may be configured as or otherwise support a means for reading a value of the second location in the second line buffer. In some examples, to support performing the second vertical binning operation, the vertical binning component 1470 may be configured as or otherwise support a means for adding a second value corresponding to the second pixel to the value of the second location in the second line buffer. In some examples, to support performing the second vertical binning operation, the vertical binning component 1470 may be configured as or otherwise support a means for writing, to the second location in the second line buffer, a second sum value based on adding the second value corresponding to the second pixel to the value of the second location in the second line buffer.

In some examples, the first set of pixel channels include a first LCR processing path and the second set of pixel channels include a second LCR processing path, and the LCR processing component 1460 may be configured as or otherwise support a means for processing the first subset of pixels using the first LCR processing path. In some examples, the first set of pixel channels include a LCR processing path and the second set of pixel channels include a second LCR processing path, and the LCR processing component 1460 may be configured as or otherwise support a means for processing the second subset of pixels using the second LCR processing path.

In some examples, to support processing the first subset of pixels using the first LCR processing path, the LCR processing component 1460 may be configured as or otherwise support a means for comparing a left pixel channel associated with the first subset of pixels to a center pixel channel associated with the set of pixels. In some examples, to support processing the first subset of pixels using the first LCR processing path, the LCR processing component 1460 may be configured as or otherwise support a means for comparing the center pixel channel associated with the set of pixels to a right pixel channel associated with the first subset of pixels.

In some examples, to support processing the second subset of pixels using the second LCR processing path, the LCR processing component 1460 may be configured as or otherwise support a means for comparing a left pixel channel associated with the second subset of pixels to a center pixel channel associated with the set of pixels. In some examples, to support processing the second subset of pixels using the second LCR processing path, the LCR processing component 1460 may be configured as or otherwise support a means for comparing the center pixel channel associated with the set of pixels to a right pixel channel associated with the second subset of pixels.

The interleaving component 1465 may be configured as or otherwise support a means for interleaving, at the interleaver, the first subset of pixels and the second subset of pixels to obtain an interleaved set of pixels. In some examples, the pixel output component 1430 may be configured as or otherwise support a means for outputting the interleaved set of pixels to a first LR processing component and a second LR processing component.

FIG. 15 shows a diagram of a system 1500 including a device 1505 that supports techniques for PDAF in accordance with aspects of the present disclosure. The device 1505 may be an example of or include the components of a device 1205, a device 1305, or a device as described herein. The device 1505 may include components for bi-directional voice and data communications including components for transmitting and receiving communications, such as a PDAF manager 1520, an I/O controller 1510, a memory 1515, a processor 1525, a display 1530, and a light source. These components may be in electronic communication or otherwise coupled (e.g., operatively, communicatively, functionally, electronically, electrically) via one or more buses (e.g., a bus 1535).

The I/O controller 1510 may manage input and output signals for the device 1505. The I/O controller 1510 may also manage peripherals not integrated into the device 1505. In some cases, the I/O controller 1510 may represent a physical connection or port to an external peripheral. In some cases, the I/O controller 1510 may utilize an operating system such as iOS®, ANDROID®, MS-DOS®, MS-WINDOWS®, OS/2®, UNIX®, LINUX®, or another known operating system. In some other cases, the I/O controller 1510 may represent or interact with a modem, a keyboard, a mouse, a touchscreen, or a similar device. In some cases, the I/O controller 1510 may be implemented as part of a processor, such as the processor 1525. In some cases, a user may interact with the device 1505 via the I/O controller 1510 or via hardware components controlled by the I/O controller 1510.

The memory 1515 may include RAM and ROM. The memory 1515 may store computer-readable, computer-executable code 1535 including instructions that, when executed by the processor 1525, cause the device 1505 to perform various functions described herein. The code 1535 may be stored in a non-transitory computer-readable medium such as system memory or other type of memory. In some cases, the code 1535 may not be directly executable by the processor 1525 but may cause a computer (e.g., when compiled and executed) to perform functions described herein. In some cases, the memory 1515 may contain, among other things, a BIOS which may control basic hardware or software operation such as the interaction with peripheral components or devices.

The processor 1525 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1525 may be configured to operate a memory array using a memory controller. In some other cases, a memory controller may be integrated into the processor 1525. The processor 1525 may be configured to execute computer-readable instructions stored in a memory (e.g., the memory 1515) to cause the device 1505 to perform various functions (e.g., functions or tasks supporting techniques for PDAF). For example, the device 1505 or a component of the device 1505 may include a processor 1525 and memory 1515 coupled to the processor 1525, the processor 1525 and memory 1515 configured to perform various functions described herein.

The display 1530 may include an LCD, an LED display, an OLED, or an AMOLED, among other examples. In some cases, the display 1530 and the I/O controller 1510 may be or represent aspects of a same component (e.g., a touchscreen) of the device 1505. The display 1530 may be any suitable display or screen allowing for user interaction or allowing for presentation of information (such as captured images and video) for viewing by a user. In some aspects, the display 1530 may be a touch-sensitive display. In some cases, the display 1530 may display images captured by sensors, where the displayed images that are captured by sensors may depend on the configuration of light sources and active sensors by the PDAF manager 1520.

The PDAF manager 1520 may support performing PDAF at the device 1505 in accordance with examples as disclosed herein. For example, the PDAF manager 1520 may be configured as or otherwise support a means for selecting a first subset of pixels of a set of pixels associated with a frame and a second subset of pixels of the set of pixels associated with the frame, each of the first subset of pixels and the second subset of pixels including at least two pixels. The PDAF manager 1520 may be configured as or otherwise support a means for performing a first output operation by outputting, from a first line buffer, the first subset of pixels to a first set of pixel channels. The PDAF manager 1520 may be configured as or otherwise support a means for performing a second output operation by outputting, from a second line buffer, the second subset of pixels to a second set of pixel channels and an interleaver. The PDAF manager 1520 may be configured as or otherwise support a means for outputting a PDAF parameter associated with the frame based on the first output operation and the second output operation.

By including or configuring the PDAF manager 1520 in accordance with examples as described herein, the device 1505 may support techniques for reduced latency, improved user experience related to reduced processing, reduced power consumption, improved coordination between devices, longer battery life, and improved utilization of processing capability.

The PDAF manager 1520, or its sub-components, may be implemented in hardware, code (e.g., software or firmware) executed by a processor, or any combination thereof. If implemented in code executed by a processor, the functions of the PDAF manager 1520, or its sub-components may be executed by a general-purpose processor, a DSP, an ASIC, an FPGA or other programmable logic device, discrete gate or transistor logic, discrete hardware components, or any combination thereof designed to perform the functions described in the present disclosure. The PDAF manager 1520, or its sub-components, may be physically located at various positions, including being distributed such that portions of functions are implemented at different physical locations by one or more physical components. In some examples, the PDAF manager 1520, or its sub-components, may be a separate and distinct component in accordance with various aspects of the present disclosure. In some examples, the PDAF manager 1520, or its sub-components, may be combined with one or more other hardware components, including but not limited to an I/O component, a camera controller, another computing device, one or more other components described in the present disclosure, or a combination thereof in accordance with various aspects of the present disclosure.

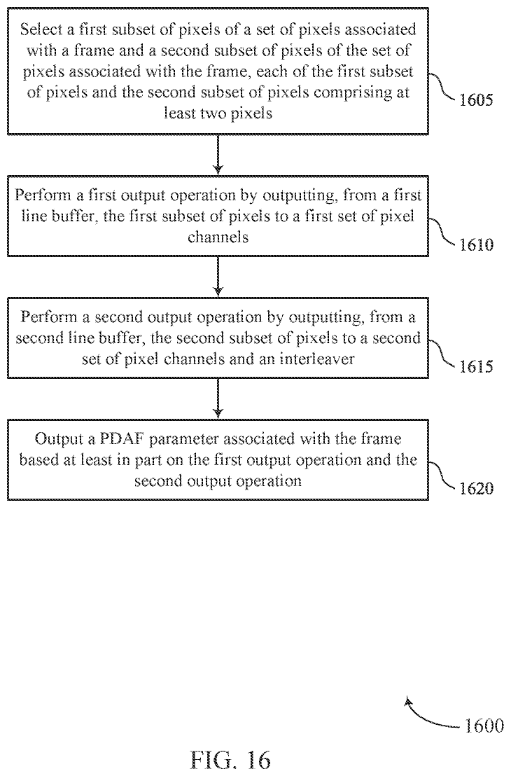

FIG. 16 shows a flowchart illustrating a method 1600 that supports techniques for PDAF in accordance with aspects of the present disclosure. The operations of the method 1600 may be implemented by a device or its components as described herein. For example, the operations of the method 1600 may be performed by a device as described with reference to FIGS. 1 through 15. In some examples, a device may execute a set of instructions to control the functional elements of the device to perform the described functions. Additionally or alternatively, the device may perform aspects of the described functions using special-purpose hardware.

At 1605, the method may include selecting a first subset of pixels of a set of pixels associated with a frame and a second subset of pixels of the set of pixels associated with the frame, each of the first subset of pixels and the second subset of pixels including at least two pixels. The operations of 1605 may be performed in accordance with examples as disclosed herein. In some examples, aspects of the operations of 1605 may be performed by a pixel selection component 1425 as described with reference to FIG. 14.

At 1610, the method may include performing a first output operation by outputting, from a first line buffer, the first subset of pixels to a first set of pixel channels. The operations of 1610 may be performed in accordance with examples as disclosed herein. In some examples, aspects of the operations of 1610 may be performed by a pixel output component 1430 as described with reference to FIG. 14.

At 1615, the method may include performing a second output operation by outputting, from a second line buffer, the second subset of pixels to a second set of pixel channels and an interleaver. The operations of 1615 may be performed in accordance with examples as disclosed herein. In some examples, aspects of the operations of 1615 may be performed by a pixel output component 1430 as described with reference to FIG. 14.

At 1620, the method may include outputting a PDAF parameter associated with the frame based on the first output operation and the second output operation. The operations of 1620 may be performed in accordance with examples as disclosed herein. In some examples, aspects of the operations of 1620 may be performed by a PDAF component 1435 as described with reference to FIG. 14.

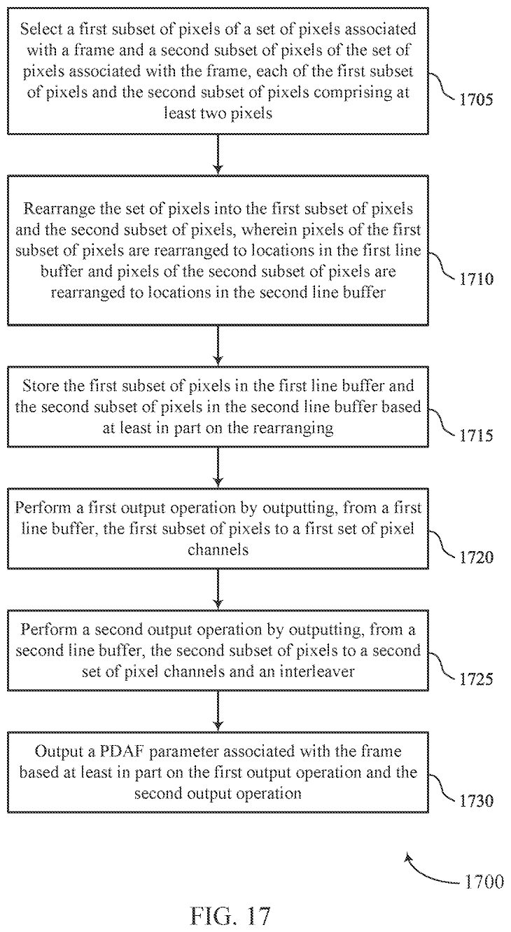

FIG. 17 shows a flowchart illustrating a method 1700 that supports techniques for PDAF in accordance with aspects of the present disclosure. The operations of the method 1700 may be implemented by a device or its components as described herein. For example, the operations of the method 1700 may be performed by a device as described with reference to FIGS. 1 through 15. In some examples, a device may execute a set of instructions to control the functional elements of the device to perform the described functions. Additionally or alternatively, the device may perform aspects of the described functions using special-purpose hardware.

At 1705, the method may include selecting a first subset of pixels of a set of pixels associated with a frame and a second subset of pixels of the set of pixels associated with the frame, each of the first subset of pixels and the second subset of pixels including at least two pixels. The operations of 1705 may be performed in accordance with examples as disclosed herein. In some examples, aspects of the operations of 1705 may be performed by a pixel selection component 1425 as described with reference to FIG. 14.

At 1710, the method may include rearranging the set of pixels into the first subset of pixels and the second subset of pixels, where pixels of the first subset of pixels are rearranged to locations in the first line buffer and pixels of the second subset of pixels are rearranged to locations in the second line buffer. The operations of 1710 may be performed in accordance with examples as disclosed herein. In some examples, aspects of the operations of 1710 may be performed by a pixel rearrangement component 1450 as described with reference to FIG. 14.

At 1715, the method may include storing the first subset of pixels in the first line buffer and the second subset of pixels in the second line buffer based on the rearranging. The operations of 1715 may be performed in accordance with examples as disclosed herein. In some examples, aspects of the operations of 1715 may be performed by a buffer component 1455 as described with reference to FIG. 14.

At 1720, the method may include performing a first output operation by outputting, from a first line buffer, the first subset of pixels to a first set of pixel channels. The operations of 1720 may be performed in accordance with examples as disclosed herein. In some examples, aspects of the operations of 1720 may be performed by a pixel output component 1430 as described with reference to FIG. 14.

At 1725, the method may include performing a second output operation by outputting, from a second line buffer, the second subset of pixels to a second set of pixel channels and an interleaver. The operations of 1725 may be performed in accordance with examples as disclosed herein. In some examples, aspects of the operations of 1725 may be performed by a pixel output component 1430 as described with reference to FIG. 14.

At 1730, the method may include outputting a PDAF parameter associated with the frame based on the first output operation and the second output operation. The operations of 1730 may be performed in accordance with examples as disclosed herein. In some examples, aspects of the operations of 1730 may be performed by a PDAF component 1435 as described with reference to FIG. 14.

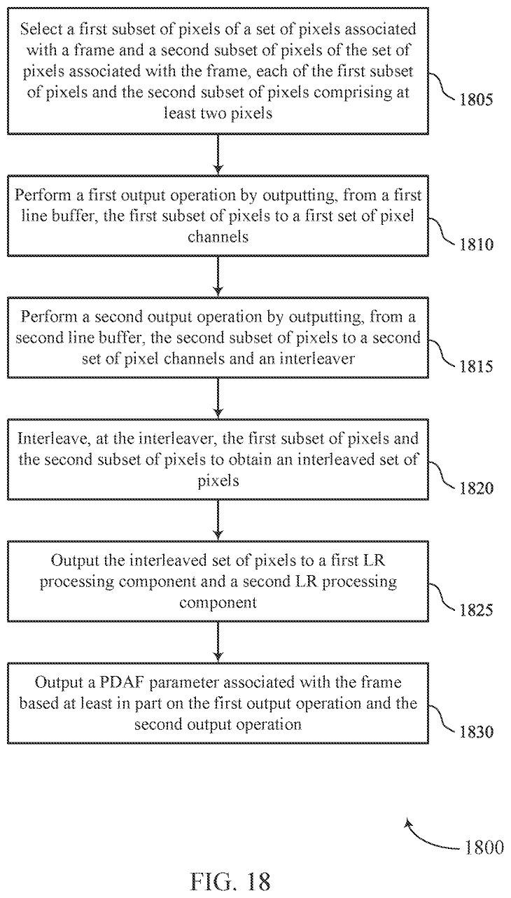

FIG. 18 shows a flowchart illustrating a method 1800 that supports techniques for PDAF in accordance with aspects of the present disclosure. The operations of the method 1800 may be implemented by a device or its components as described herein. For example, the operations of the method 1800 may be performed by a device as described with reference to FIGS. 1 through 17. In some examples, a device may execute a set of instructions to control the functional elements of the device to perform the described functions. Additionally or alternatively, the device may perform aspects of the described functions using special-purpose hardware.

At 1805, the method may include selecting a first subset of pixels of a set of pixels associated with a frame and a second subset of pixels of the set of pixels associated with the frame, each of the first subset of pixels and the second subset of pixels including at least two pixels. The operations of 1805 may be performed in accordance with examples as disclosed herein. In some examples, aspects of the operations of 1805 may be performed by a pixel selection component 1425 as described with reference to FIG. 14.

At 1810, the method may include performing a first output operation by outputting, from a first line buffer, the first subset of pixels to a first set of pixel channels. The operations of 1810 may be performed in accordance with examples as disclosed herein. In some examples, aspects of the operations of 1810 may be performed by a pixel output component 1430 as described with reference to FIG. 14.

At 1815, the method may include performing a second output operation by outputting, from a second line buffer, the second subset of pixels to a second set of pixel channels and an interleaver. The operations of 1815 may be performed in accordance with examples as disclosed herein. In some examples, aspects of the operations of 1815 may be performed by a pixel output component 1430 as described with reference to FIG. 14.

At 1820, the method may include interleaving, at the interleaver, the first subset of pixels and the second subset of pixels to obtain an interleaved set of pixels. The operations of 1820 may be performed in accordance with examples as disclosed herein. In some examples, aspects of the operations of 1820 may be performed by an interleaving component 1465 as described with reference to FIG. 14.

At 1825, the method may include outputting the interleaved set of pixels to a first LR processing component and a second LR processing component. The operations of 1825 may be performed in accordance with examples as disclosed herein. In some examples, aspects of the operations of 1825 may be performed by a pixel output component 1430 as described with reference to FIG. 14.

At 1830, the method may include outputting a PDAF parameter associated with the frame based on the first output operation and the second output operation. The operations of 1830 may be performed in accordance with examples as disclosed herein. In some examples, aspects of the operations of 1830 may be performed by a PDAF component 1435 as described with reference to FIG. 14.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for performing phase-detection autofocus at a device, comprising:
selecting a first subset of pixels of a set of pixels associated with a frame and a second subset of pixels of the set of pixels associated with the frame, each of the first subset of pixels and the second subset of pixels comprising at least two pixels;
performing a first output operation by outputting, from a first line buffer, the first subset of pixels to a first set of pixel channels;
performing a second output operation by outputting, from a second line buffer, the second subset of pixels to a second set of pixel channels and an interleaver; and
outputting a phase detection autofocus parameter associated with the frame based at least in part on the first output operation and the second output operation.

2. The method of claim 1, further comprising:
performing a first uniformity correction on the first subset of pixels to obtain a corrected first subset of pixels, wherein outputting the first subset of pixels to the first set of pixel channels comprises outputting the corrected first subset of pixels; and
writing, to the first line buffer, the corrected first subset of pixels.

3. The method of claim 2, further comprising:
performing a second uniformity correction on the second subset of pixels to obtain a corrected second subset of pixels, wherein outputting the second subset of pixels to the second set of pixel channels and the interleaver comprises outputting the corrected second subset of pixels.

4. The method of claim 1, further comprising:
rearranging the set of pixels into the first subset of pixels and the second subset of pixels, wherein pixels of the first subset of pixels are rearranged to locations in the first line buffer and pixels of the second subset of pixels are rearranged to locations in the second line buffer; and
storing the first subset of pixels in the first line buffer and the second subset of pixels in the second line buffer based at least in part on the rearranging.

5. The method of claim 4, wherein rearranging the set of pixels into the first subset of pixels and the second subset of pixels comprises:
rearranging a first pixel of the set of pixels to a first location in the first line buffer and rearranging a second pixel of the set of pixels to a second location in the second line buffer, the method further comprising:
performing a first vertical binning operation for the first pixel at the first location in the first line buffer; and
performing a second vertical binning operation for the second pixel at the second location in the second line buffer.

6. The method of claim 5, wherein performing the first vertical binning operation comprises:
reading a value of the first location in the first line buffer;
adding a first value corresponding to the first pixel to the value of the first location in the first line buffer; and
writing, to the first location in the first line buffer, a first sum value based at least in part on adding the first value corresponding to the first pixel to the value of the first location in the first line buffer.

7. The method of claim 5, wherein performing the second vertical binning operation comprises:
reading a value of the second location in the second line buffer;
adding a second value corresponding to the second pixel to the value of the second location in the second line buffer; and
writing, to the second location in the second line buffer, a second sum value based at least in part on adding the second value corresponding to the second pixel to the value of the second location in the second line buffer.

8. The method of claim 1, wherein the first set of pixel channels comprise a first left, center, right (LCR) processing path and the second set of pixel channels comprise a second LCR processing path, the method further comprising:
processing the first subset of pixels using the first LCR processing path; and
processing the second subset of pixels using the second LCR processing path.

9. The method of claim 8, wherein processing the first subset of pixels using the first LCR processing path comprises:
comparing a left pixel channel associated with the first subset of pixels to a center pixel channel associated with the set of pixels; and
comparing the center pixel channel associated with the set of pixels to a right pixel channel associated with the first subset of pixels.

10. The method of claim 8, wherein processing the second subset of pixels using the second LCR processing path comprises:
comparing a left pixel channel associated with the second subset of pixels to a center pixel channel associated with the set of pixels; and
comparing the center pixel channel associated with the set of pixels to a right pixel channel associated with the second subset of pixels.

11. The method of claim 1, further comprising:
interleaving, at the interleaver, the first subset of pixels and the second subset of pixels to obtain an interleaved set of pixels; and
outputting the interleaved set of pixels to a first left, right (LR) processing component and a second LR processing component.

12. An apparatus for performing phase-detection autofocus, comprising:
a processor;
memory coupled with the processor; and
instructions stored in the memory and executable by the processor to cause the apparatus to:
select a first subset of pixels of a set of pixels associated with a frame and a second subset of pixels of the set of pixels associated with the frame, each of the first subset of pixels and the second subset of pixels comprising at least two pixels;
perform a first output operation by outputting, from a first line buffer, the first subset of pixels to a first set of pixel channels;
perform a second output operation by outputting, from a second line buffer, the second subset of pixels to a second set of pixel channels and an interleaver; and
output a phase detection autofocus parameter associated with the frame based at least in part on the first output operation and the second output operation.

13. The apparatus of claim 12, wherein the instructions are further executable by the processor to cause the apparatus to:
perform a first uniformity correction on the first subset of pixels to obtain a corrected first subset of pixels, wherein the instructions to output the first subset of pixels to the first set of pixel channels are further executable by the processor to cause the apparatus to:
output the corrected first subset of pixels; and
write, to the first line buffer, the corrected first subset of pixels.

14. The apparatus of claim 13, wherein the instructions are further executable by the processor to cause the apparatus to:
perform a second uniformity correction on the second subset of pixels to obtain a corrected second subset of pixels, wherein the instructions to output the second subset of pixels to the second set of pixel channels and the interleaver are further executable by the processor to cause the apparatus to:
output the corrected second subset of pixels.

15. The apparatus of claim 12, wherein the instructions are further executable by the processor to cause the apparatus to:
rearrange the set of pixels into the first subset of pixels and the second subset of pixels, wherein pixels of the first subset of pixels are rearranged to locations in the first line buffer and pixels of the second subset of pixels are rearranged to locations in the second line buffer; and
store the first subset of pixels in the first line buffer and the second subset of pixels in the second line buffer based at least in part on the rearranging.

16. The apparatus of claim 15, wherein the instructions to rearrange the set of pixels into the first subset of pixels and the second subset of pixels are further executable by the processor to cause the apparatus to:
rearrange a first pixel of the set of pixels to a first location in the first line buffer and rearrange a second pixel of the set of pixels to a second location in the second line buffer, wherein the instructions are further executable to cause the apparatus to:
perform a first vertical binning operation for the first pixel at the first location in the first line buffer; and
perform a second vertical binning operation for the second pixel at the second location in the second line buffer.

17. The apparatus of claim 16, wherein the instructions to perform the first vertical binning operation are further executable by the processor to cause the apparatus to:
read a value of the first location in the first line buffer;
add a first value corresponding to the first pixel to the value of the first location in the first line buffer; and
write, to the first location in the first line buffer, a first sum value based at least in part on adding the first value corresponding to the first pixel to the value of the first location in the first line buffer.

18. The apparatus of claim 16, wherein the instructions to perform the second vertical binning operation are further executable by the processor to cause the apparatus to:
read a value of the second location in the second line buffer;
add a second value corresponding to the second pixel to the value of the second location in the second line buffer; and
write, to the second location in the second line buffer, a second sum value based at least in part on adding the second value corresponding to the second pixel to the value of the second location in the second line buffer.

19. The apparatus of claim 12, wherein the first set of pixel channels comprise a first left, center, right (LCR) processing path and the second set of pixel channels comprise a second LCR processing path, and the instructions are further executable by the processor to cause the apparatus to:
process the first subset of pixels using the first LCR processing path; and
process the second subset of pixels using the second LCR processing path.

20. An apparatus for performing phase-detection autofocus, comprising:
means for selecting a first subset of pixels of a set of pixels associated with a frame and a second subset of pixels of the set of pixels associated with the frame, each of the first subset of pixels and the second subset of pixels comprising at least two pixels;
means for performing a first output operation by outputting, from a first line buffer, the first subset of pixels to a first set of pixel channels;
means for performing a second output operation by outputting, from a second line buffer, the second subset of pixels to a second set of pixel channels and an interleaver; and
means for outputting a phase detection autofocus parameter associated with the frame based at least in part on the first output operation and the second output operation.
